(19) United States
(12) Patent Application Publication
(10) Pub. No.: US 2026/0329492 A1
(43) Pub. Date: Oct. 22, 2026

(54) STORAGE MEDIUM STORING APPLICATION PROGRAM THAT SUPPORTS GENERAL PURPOSE PROGRAM CAPABLE OF CAUSING INFORMATION PROCESSING APPARATUS TO OBTAIN CAPABILITY INFORMATION OF PRINTING APPARATUS, INFORMATION PROCESSING APPARATUS, AND CONTROL METHOD

(71) Applicant: CANON KABUSHIKI KAISHA, Tokyo (JP)

(72) Inventor: HIROAKI MORIMOTO, Kanagawa (JP)

(21) Appl. No.: 19/638,235

(22) Filed: Apr. 3, 2026

(30) Foreign Application Priority Data
Apr. 22, 2025 (JP) 2025-070828

(51) Int. Cl. G06F 3/12

(52) U.S. Cl. CPC G06F 3/1232; G06F 3/1204; G06F 3/1228; G06F 3/1285

(57) ABSTRACT

A mechanism for improving the convenience of an extension application is provided. A non-transitory computer-readable storage medium stores an application program that supports a general purpose program capable of causing an information processing apparatus to obtain capability information of a printing apparatus in accordance with the Internet Printing Protocol, the application program for causing a computer to execute a display control step of displaying an information transmission permission dialog that includes a permission section, which accepts a choice that consents to collection of usage information to be used for usage analysis, and a non-permission section, which accepts a choice that does not consent to the collection, an accepting step of accepting the choice of the permission section or the non-permission section, and a transmitting step of, in a case where the permission section has been chosen, collecting the usage information and transmitting the collected usage information to an external server.

### BACKGROUND

### Field of the Technology

The present disclosure relates to a storage medium storing an application program, an information processing apparatus, and a control method.

### Description of the Related Art

A printer driver, which has been installed on a host computer as control software for controlling a printing apparatus, has been known. By using the printer driver, it is possible to instruct the printing apparatus connected to the host computer to perform printing. An operating system (hereinafter, referred to as “an OS”), which is basic software, has been installed on the host computer. The printer driver is configured in accordance with specifications defined by the OS. The printer driver operates (runs) by being invoked from the OS. A vendor that provides the printing apparatus provides a printer driver that conforms to the specifications of the OS. As a result, it is possible to provide a means for instructing the printing apparatus to perform printing by using the OS.

In recent years, Windows (registered trademark) has provided a standard class driver (hereinafter, also referred to as “a standard driver”) that is capable of being commonly used among printing apparatuses provided by a plurality of vendors. Such a standard driver is bundled with the package of the OS, and is capable of being easily used by connecting any printing apparatus to the host computer. By providing the standard driver, there is no need to separately install a specific printer driver suitable for the any printing apparatus. Therefore, the standard driver is highly convenient.

In addition, the standard driver is configured to be able to designate print functions in accordance with Print Capabilities that have been generated based on information obtained from the printing apparatus connected to the host computer. As a result, a user who uses the standard driver is able to designate print functions in accordance with the capabilities of the printing apparatus connected to the host computer, even though the user uses one standard driver.

In addition, the standard driver is capable of being associated with an application for function extension (hereinafter, also referred to as “an extension application”). The extension application is provided by the vendor that provides the printing apparatus. The extension application is capable of providing functions that are not capable of being realized by the standard driver alone (extended functions) by editing print function information that has been generated by the standard driver.

Japanese Laid-Open Patent Publication (kokai) No. 2019-74906 discloses a technique that provides a graphical user interface (hereinafter, referred to as “a GUI”) that, for example, displays a print preview screen, by using an extension application. Even in the case where the extension application has been associated with the standard driver, the extension application displays the print preview screen. As a result, the user is able to know what the print result will look like (to know an impression of the print result) before printing is performed by the printing apparatus. A further improvement in convenience is desired for such an extension application.

### SUMMARY

The present disclosure provides a mechanism for improving the convenience of an extension application.

Accordingly, a first aspect of the present disclosure provides a non-transitory computer-readable storage medium storing an application program that supports a general purpose program capable of causing an information processing apparatus to obtain capability information of a printing apparatus in accordance with the Internet Printing Protocol, the application program for causing a computer to execute a display control step of displaying an information transmission permission dialog that includes a permission section, which accepts a choice that consents to collection of usage information to be used for usage analysis, and a non-permission section, which accepts a choice that does not consent to the collection, an accepting step of accepting the choice of the permission section or the non-permission section, and a transmitting step of, in a case where the permission section has been chosen, collecting the usage information and transmitting the collected usage information to an external server.

Accordingly, a second aspect of the present disclosure provides an information processing apparatus that retains an application program that supports a general purpose program capable of causing an information processing apparatus to obtain capability information of a printing apparatus in accordance with the Internet Printing Protocol, the information processing apparatus comprising at least one processor, and a memory coupled to the processor storing the application program that, when executed by the processor, causes the processor to function as a display unit that displays an information transmission permission dialog that includes a permission section, which accepts a choice that consents to collection of usage information to be used for usage analysis, and a non-permission section, which accepts a choice that does not consent to the collection, an accepting unit that accepts the choice of the permission section or the non-permission section, and a transmitting unit that, in a case where the permission section has been chosen, collects the usage information and transmitting the collected usage information to an external server.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of a printing system according to a first embodiment.

FIGS. 2A and 2B are configuration diagrams of the printing system according to the first embodiment.

FIG. 3 is a flowchart that illustrates the flow of adding a borderless printing function to print function information.

FIG. 4 illustrates an example of a sheet information list returned by a printing apparatus by using a media-col-database attribute value.

FIGS. 5A, 5B, and 5C illustrate examples of a print setting screen displayed by a print setting screen extending unit.

FIG. 6 illustrates an example of a Print Ticket in which borderless printing and a print preview have been selected.

FIG. 7 is a sequence diagram that illustrates the flow of starting up a print data editing unit UI display unit from a print data editing unit.

FIGS. 8A, 8B, and 8C are screen diagrams that each illustrate a print preview screen displayed by the print data editing unit UI display unit.

FIGS. 9A and 9B show a flowchart that illustrates the flow of a processing performed by the print data editing unit UI display unit to generate a print preview image during borderless printing.

FIG. 10 is a schematic diagram that illustrates an example of extension amounts for borderless printing of the printing apparatus.

FIGS. 11A and 11B show a flowchart that illustrates the flow of a processing performed by the print data editing unit UI display unit to generate an image for print preview in the case where a function related to 180-degree rotation of an image has been selected.

FIGS. 12A and 12B are screen diagrams that each illustrate a print preview screen when the 180-degree rotation of the image is selected, which is displayed by the print data editing unit UI display unit.

FIG. 13 is a sequence diagram that illustrates the flow of the print data editing unit and the print data editing unit UI display unit when setting the extension amount for borderless printing.

FIGS. 14A and 14B are screen diagrams that each illustrate a print preview screen displayed by the print data editing unit UI display unit, on which the extension amount for borderless printing is capable of being set.

FIG. 15 is a screen diagram that illustrates an overview dialog, which is a first first-time startup dialog.

FIG. 16 is a screen diagram that illustrates an information transmission permission dialog, which is a second first-time startup dialog.

FIG. 17 is a screen diagram that illustrates an independent startup screen of an extension application.

FIG. 18 illustrates a description example of a resource file.

### DESCRIPTION OF THE EMBODIMENTS

The present disclosure will now be described in detail below with reference to the accompanying drawings showing embodiments thereof.

Hereinafter, embodiments of the present disclosure will be described in detail with reference to the accompanying drawings. It should be noted that each of the following embodiments does not limit the present disclosure as defined by the claims, and not all of the combinations of features described in each of the following embodiments are necessarily essential to the solving means of the present disclosure.

It should be noted that the same components are given the same reference numerals and their descriptions are omitted.

### First embodiment

### Hardware configuration of printing system

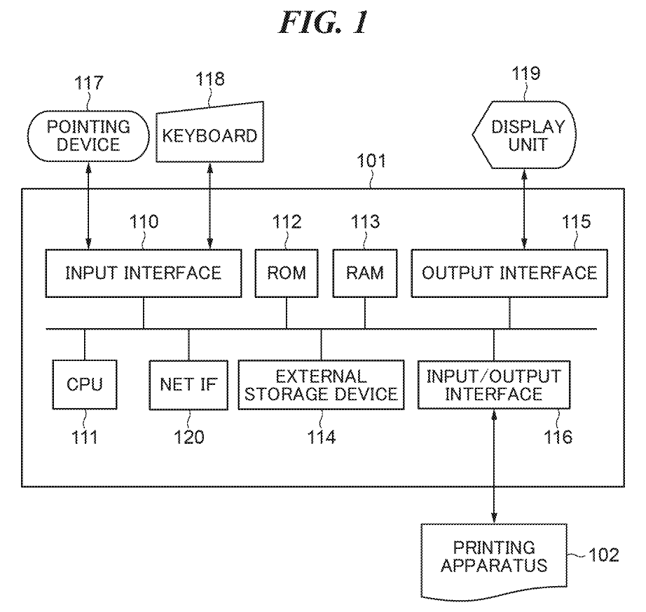

FIG. 1 is a block diagram that illustrates a hardware configuration of a printing system that includes a host computer 101 and a printing apparatus 102. In FIG. 1, the host computer 101 is an example of an information processing apparatus. As shown in FIG. 1, the host computer 101 includes an input interface 110, a central processing unit (a CPU) 111, a read only memory (a ROM) 112, a random access memory (a RAM) 113, an external storage device 114, an output interface 115, a NETIF 120, and an input/output interface 116. Input devices such as a keyboard 118 and a pointing device 117 are connected to the input interface 110. A display device such as a display unit 119 is connected to the output interface 115. The NETIF 120 is a network interface. The NETIF 120 controls data transfer between the host computer 101 and an external device (not shown) via a network (not shown). The ROM 112 stores an initialization program. The external storage device 114 stores an application program group (a group of application programs), an operating system (an OS), print data generation software, and other various types of data. The RAM 113 is used as a working memory or the like when executing various kinds of programs that have been stored in the external storage device 114. As a result, the various kinds of programs become able to run within the host computer 101.

It should be noted that in the first embodiment, the CPU 111 performs processing in accordance with the procedures of the programs that have been stored in the ROM 112. As a result, the CPU 111 executes functions of the host computer 101, which will be described below, and processing of the host computer 101 according to flowcharts, which will be described below. The printing apparatus 102, which is an output device, is connected to the host computer 101 via the input/output interface 116. In FIG. 1, the host computer 101 and the printing apparatus 102 are configured as separate apparatuses. However, the host computer 101 and the printing apparatus 102 may be configured as a single information processing apparatus. It should be noted that in the first embodiment, an inkjet printer that performs printing by ejecting ink onto a sheet surface (a paper sheet surface) will be described as an example of the printing apparatus 102. However, the printing apparatus 102 may be an apparatus that performs printing by using another method (for example, an electrophotographic method). In addition, the host computer 101 may be a desktop type personal computer, a smartphone, or a notebook type personal computer.

### Configuration of printing system centered on software

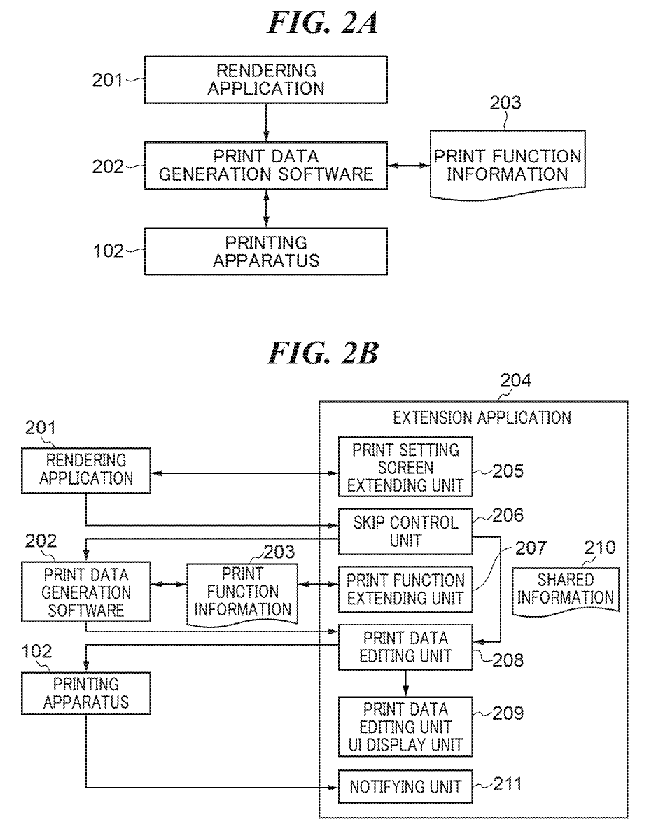

FIGS. 2A and 2B are diagrams that each schematically illustrate the configuration of the printing system centered on software. Here, the printing system using the host computer 101 that is equipped with Windows (registered trademark) by Microsoft (registered trademark) as its operating system (its OS) will be described. FIG. 2A is a diagram that illustrates a general configuration in the case where an extension application 204 has not been associated with print data generation software 202 and the printing apparatus 102. The extension application 204 is an application program that supports a general purpose program.

A rendering application 201 is software that creates contents to be printed (rendering data). The rendering application 201 is, for example, a document creation application, or a spreadsheet application. When the rendering application 201 receives a print request from a user, the rendering application 201 issues a print instruction to the OS. The print instruction includes print setting information for instructing the operations of the print data generation software 202 and the printing apparatus 102. The print setting information is also referred to as “a Print Ticket” (hereinafter, also referred to as “a PT”).

In order to output the print setting information, the rendering application 201 is capable of causing to display a print setting screen. The print setting screen is provided by the print data generation software 202, the OS, or the rendering application 201. The print setting screen includes objects (hereinafter, also referred to as “control items”) that indicate settable print functions, and control items that indicate setting values for the objects. The control items are provided in accordance with capability information obtained from the print data generation software 202 (information capable of being set as a print setting). The capability information is also referred to as “Print Capabilities” (hereinafter, also referred to as “PC”). The print data generation software 202 determines (decides) the PC based on print function information 203. The print function information 203 is data indicating all settable print functions, setting values for the all settable print functions, and print functions in which exclusive relationships between the setting values have been described. The print function information 203 is also referred to as “Print Device Capabilities (PDC)”. The print function information 203 is included in a configuration file of the print data generation software 202. The print function information 203 is stored in the external storage device 114 as an unchangeable file. Alternatively, the print function information 203 is capable of being dynamically generated by the print data generation software 202. The generated print function information 203 is capable of being edited. A configuration may be adopted in which the print data generation software 202 or the OS obtains attribute data of the printing apparatus from the printing apparatus 102, and then the print data generation software 202 or the OS generates the print function information 203 in accordance with attribute information within the obtained attribute data.

The attribute data of the printing apparatus 102 is obtained by issuing a “Get-Printer-Attributes” operation of the Internet Printing Protocol (the IPP) to the printing apparatus 102. A response to the “Get-Printer-Attributes” operation includes attribute information indicating functions that are capable of being designated in the printing apparatus 102 (capabilities of the printing apparatus 102), and setting values related to the attribute information. This response is saved (stored) in the RAM 113.

With such a configuration, the print data generation software 202 is capable of allowing the user to designate print functions that are capable of being used in each printing apparatus 102 connected to the host computer 101 (print functions available on the each printing apparatus 102 connected to the host computer 101) depending on the each printing apparatus 102 connected to the host computer 101. In other words, even in the case where the printing apparatus 102 has different functions or is developed by a different vendor, the print data generation software 202 is capable of allowing the user to designate print functions available on the printing apparatus 102 that has different functions or is developed by a different vendor. It should be noted that in the first embodiment, a configuration will be described in which an IPP Class Driver or UP Class Driver that is included in Windows (registered trademark) has been used as the print data generation software 202. The IPP Class Driver and the UP Class Driver are printer drivers that each execute a printing processing in accordance with the specifications of a standard printing protocol called the IPP (examples of the general purpose program). The IPP Class Driver and the UP Class Driver are bundled with the package of the OS. Here, the general purpose program causes the host computer 101 to obtain capability information of the printing apparatus 102 in accordance with the Internet Printing Protocol.

The IPP Class Driver and the UP Class Driver are not specific printer drivers (unique printer drivers) depending on the model of the printing apparatus 102. On the other hand, the IPP Class Driver and the UP Class Driver are standard class drivers that each are capable of transmitting print data to a plurality of different printing apparatuses 102 that are provided by a plurality of different manufacturers or vendors. The IPP Class Driver is a standard driver that executes local printing in accordance with the specifications of the standard printing protocol called the IPP. The UP Class Driver is a standard driver that executes cloud printing in accordance with the specifications of the standard printing protocol called the IPP. It should be noted that in the case where the cloud printing is executed by using the UP Class Driver, the print data will not be transmitted directly to the printing apparatus 102. The print data will be transmitted to the printing apparatus 102 via a cloud printing-related service. The printing apparatus 102 executes printing of the transmitted print data. In addition, the IPP Class Driver and the UP Class Driver obtain the capability information of the printing apparatus 102 connected to the host computer 101. The IPP Class Driver and the UP Class Driver generate the print function information 203 based on the obtained capability information. As a result, the IPP Class Driver and the UP Class Driver allow the user to designate functions that are supported by the printing apparatus 102 connected to the host computer 101.

The OS generates intermediate data (also referred to as “input data”) based on the print instruction that has been output from the rendering application 201 (the print instruction that has been issued by the rendering application 201). The OS transmits the generated intermediate data to the print data generation software 202. It should be noted that the data that the rendering application 201 outputs for printing is data in a Graphic Device Interface format (GDI format data). Alternatively, the data that the rendering application 201 outputs for printing is data in an XML Paper Specification format (XPS format data). In the case where the data output by the rendering application 201 is GDI format data, the OS converts the GDI format data into XPS format data. Furthermore, the OS transmits the converted XPS format data to the print data generation software 202 as the intermediate data. On the other hand, in the case where the data output by the rendering application 201 is XPS format data, the OS transmits the XPS format data to the print data generation software 202 as the intermediate data. It should be noted that the intermediate data includes the rendering data, which is information about a picture (an image) to be formed on a sheet surface (a paper sheet surface), and the print setting information that has been set by the user.

The print data generation software 202 converts the obtained intermediate data into print data that is capable of being interpreted by the printing apparatus 102. The print data generation software 202 transmits the converted print data to the printing apparatus 102. It should be noted that the print data includes the rendering data, which is the information about the picture (the image) to be formed on a sheet surface (a paper sheet surface), and print setting attribute information (attribute information for designating a print setting), which has been generated based on the print setting information that has been set by the user. The print setting attribute information includes the attribute information indicating the functions that are capable of being designated in the printing apparatus 102 (the capabilities of the printing apparatus), and the setting values related to the attribute information.

The printing apparatus 102 performs printing on the sheet surface (the paper sheet surface) based on the print data that has been transmitted from the print data generation software 202. At this time, the printing apparatus 102 forms the rendering data, which is included in the print data, on the sheet surface (the paper sheet surface) by performing an operation in accordance with the print setting attribute information included in the print data. The print setting attribute information includes attribute information for designating print quality (image quality priority, speed priority, or the like), and double-sided printing or the like, and setting values of the attribute information. For example, in the case where the print setting attribute information includes attribute information designating double-sided printing, the printing apparatus 102 executes double-sided printing.

FIG. 2B is a block diagram that illustrates a configuration in the case where the extension application 204 has been associated with the print data generation software 202 and the printing apparatus 102. It should be noted that configurations and processes not specifically mentioned below are equivalent to those in FIG. 2A. The extension application 204 is software for extending the functions of the print data generation software 202. The extension application 204 is software that is not included in the OS in advance (is not bundled with the OS). The extension application 204 is downloaded from a server via the Internet by the user operating the host computer 101. The downloaded extension application 204 is installed on the host computer 101. Alternatively, the extension application 204 may be automatically installed on the host computer 101 when the printing apparatus 102 is connected to the host computer 101. In the case where the printing apparatus 102 is connected to the host computer 101, the OS obtains device identification information from the printing apparatus 102. Furthermore, the OS downloads the extension application 204 corresponding to the obtained device identification information from the server via the Internet. The OS installs the downloaded extension application 204 on the host computer 101. In other words, the print data generation software 202 and the extension application 204 are retained (stored) in the host computer 101 as separate files.

It should be noted that the print data generation software 202 and the extension application 204 may be updated and upgraded. The update processing of the print data generation software 202 and the update processing of the extension application 204 are performed at different timings. In other words, the timing at which the print data generation software 202 is obtained from the host computer 101 and the timing at which the extension application 204 is obtained from the host computer 101 are different from each other. In addition, a trigger for obtaining the print data generation software 202 from the host computer 101 is also different from a trigger for obtaining the extension application 204 from the host computer 101. It should be noted that in the case where the extension application 204 has been installed on the host computer 101, the OS associates the extension application 204 with the print data generation software 202 and the printing apparatus 102. As shown in FIG. 2B, the extension application 204 described in the first embodiment includes a print setting screen extending unit 205, a skip control unit 206, and a print function extending unit 207. In addition, the extension application 204 described in the first embodiment includes a print data editing unit 208, a notifying unit 211, and a print data editing unit UI display unit 209. In addition, the extension application 204 described in the first embodiment includes shared information 210 that is capable of being commonly accessed from each unit of the print setting screen extending unit 205, the skip control unit 206, the print function extending unit 207, the print data editing unit 208, the notifying unit 211, and the print data editing unit UI display unit 209. The shared information 210 is a file that has been saved (stored) in the external storage device 114 of the host computer 101 or information that has been stored in the RAM 113 of the host computer 101.

The extension application 204 is able to freely perform writing and reading out information into and from the shared information 210 by using an application program interface (an API) provided by the OS. In addition, the shared information 210 has been allocated as an area in which application-specific information is capable of being stored. The shared information 210 is also capable of storing information other than the attribute data of the printing apparatus 102. The shared information 210 is information that is different from the print function information 203 to be generated by the print data generation software 202 or the OS in order to designate the print functions available on the printing apparatus 102 connected to the host computer 101. It should be noted that the extension application 204 may terminate its operation each time the processing of one of the print setting screen extending unit 205, the skip control unit 206, the print function extending unit 207, the print data editing unit 208, the notifying unit 211, and the print data editing unit UI display unit 209 ends. In this case, the OS starts up the extension application 204 every time the OS receives a request to use one of the print setting screen extending unit 205, the skip control unit 206, the print function extending unit 207, the print data editing unit 208, the notifying unit 211, and the print data editing unit UI display unit 209. In addition, as another configuration, for example, when the processing of the print setting screen extending unit 205 ends, the OS causes to terminate the operation of the extension application 204. On the other hand, the OS may keep the extension application 204 running even after the processing of the skip control unit 206 ends. Furthermore, the extension application 204 may cancel the processing of one of the print setting screen extending unit 205, the skip control unit 206, the print function extending unit 207, the print data editing unit 208, the notifying unit 211, and the print data editing unit UI display unit 209 during the processing of one of the print setting screen extending unit 205, the skip control unit 206, the print function extending unit 207, the print data editing unit 208, the notifying unit 211, and the print data editing unit UI display unit 209. In the case where the processing has been cancelled, a job being processed in a print queue is deleted by the OS.

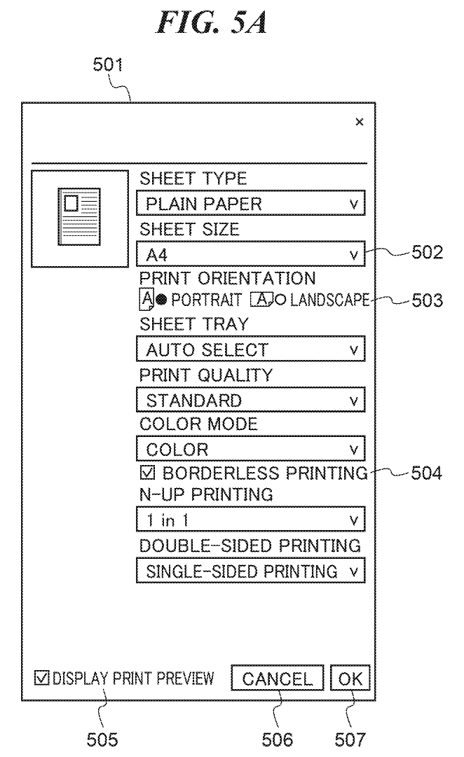

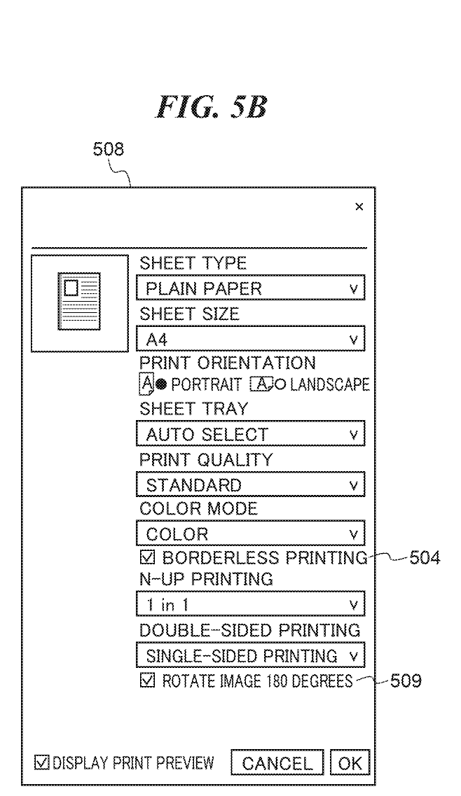

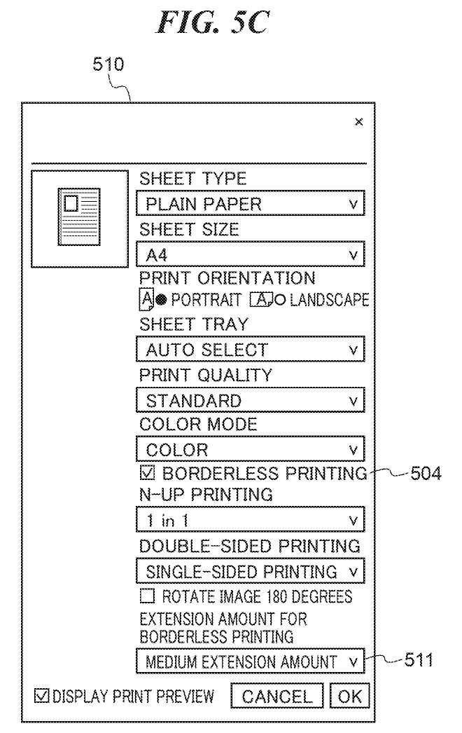

When the rendering application 201 receives a print request from the user, the rendering application 201 issues a print instruction to the OS. Also with the configuration of FIG. 2B, as with the configuration of FIG. 2A, the rendering application 201 is capable of causing to display a print setting screen. In the configuration of FIG. 2B, the rendering application 201 causes to display a print setting screen provided by the extension application 204. Specifically, the rendering application 201 causes to display a print setting screen provided by the print setting screen extending unit 205 included in the extension application 204. It should be noted that whether the print setting screen provided by the print setting screen extending unit 205 is displayed or not depends on the user's operation. As an example, a case will be described in which the rendering application 201 is a document creation application or a spreadsheet application. A property setting button is displayed on a print setting screen of the document creation application or the spreadsheet application. The print setting screen is displayed when the user presses the property setting button. The print setting screen extending unit 205 will be described in detail below with reference to FIGS. 5A, 5B, and 5C. In addition, when the rendering application 201 receives the print request from the user, the rendering application 201 issues the print instruction to the OS, which then starts up the skip control unit 206. The skip control unit 206 controls whether or not to skip the processing of the print data generation software 202. Here, the skip control unit 206 is not capable of obtaining the intermediate data and the print setting information. After the skip control processing performed by the skip control unit 206, the OS generates intermediate data based on the print instruction output from the rendering application 201. The OS transmits the generated intermediate data to the print data generation software 202.

Here, in the case where the skip control is not performed by the skip control unit 206, the intermediate data is processed by the print data generation software 202 into print data that is capable of being interpreted by the printing apparatus 102. The print data generation software 202 transmits, to the print data editing unit 208, the processed print data (the print data that is capable of being interpreted by the printing apparatus 102). On the other hand, in the case where the processing of the print data generation software 202 is skipped, the intermediate data is not processed by the print data generation software 202. The intermediate data is transmitted from the print data generation software 202 to the print data editing unit 208. As a result, the intermediate data becomes capable of being processed by the print data editing unit 208. The case where it is preferable to skip the processing of the print data generation software 202 is, for example, a case where an enlargement/reduction processing is performed by the print data editing unit 208. The intermediate data is retained in a vector format. The data retained in the vector format is less susceptible to degradation when enlarged or reduced. For this reason, in a configuration in which the print data generation software 202 outputs an image in a raster format, it is preferable to skip the processing of the print data generation software 202. In this case, the intermediate data is processed by the print data editing unit 208.

The print data editing unit 208 edits the intermediate data that has been transmitted from the print data generation software 202 or the print data that has been processed by the print data generation software 202. As an example, in the case where the content of editing is N-up printing (layout printing), the print data editing unit 208 changes the layout of the intermediate data or the print data based on a print setting for N-up printing that has been received from the OS. In addition, the print data editing unit 208 is capable of requesting the OS to display a user interface screen (a UI screen) on the display unit 119. The OS starts up the print data editing unit UI display unit 209 in response to the request from the print data editing unit 208. The print data editing unit UI display unit 209 is capable of displaying, for example, the layout result of the intermediate data or the print data on the display unit 119 as a preview screen. It should be noted that in a state where the print data editing unit UI display unit 209 keeps the UI screen open, the print data editing unit 208 does not transmit the print data to the printing apparatus 102. By closing the UI screen displayed by the print data editing unit UI display unit 209, the print data editing unit 208 executes the processing of transmitting the print data.

After the print data editing unit 208 edits the print data, the print data that has been edited is transmitted to the printing apparatus 102 via the OS. The printing apparatus 102 performs printing on a sheet surface (a paper sheet surface) based on the received print data. It should be noted that in the case where the processing of the print data generation software 202 has been skipped by the skip control unit 206, the print data editing unit 208 may convert the received intermediate data into print data that is capable of being interpreted by the printing apparatus 102. In addition, in order to convert the intermediate data into the print data, the function provided by the OS may be used.

In addition, the extension application 204 includes the print function extending unit 207. The print function extending unit 207 is able to edit the print function information 203 that has been generated by the print data generation software 202 or the OS. As a result, the print function extending unit 207 is able to perform the addition of functions provided by the extension application 204. In addition, the print function extending unit 207 is able to perform the addition of functions that are supported by the printing apparatus 102 but not supported by the print data generation software 202. Furthermore, the print function extending unit 207 is able to perform the addition of the exclusive relationships between the setting values of the print functions, and the like.

The OS starts up the print function extending unit 207 when the extension application 204 has been first associated with the printing apparatus 102 and the print data generation software 202. Furthermore, the OS may start up the print function extending unit 207 at another timing, for example, at a timing when the OS is started up. The print function extending unit 207 detects an extended function of the printing apparatus 102. The print function extending unit 207 is able to add the extended function that has been detected to the print function information 203. As a result, the print function extending unit 207 is able to handle a case where a printing-related function is extended by adding an optional device (for example, a finisher) to the printing apparatus 102.

In addition, the extension application 204 includes the notifying unit 211. The notifying unit 211 is able to display a notification to the user in response to an error occurring in the printing apparatus 102. For example, when a sheet-out error (a paper-out error) occurs in the printing apparatus 102, the print data generation software 202 detects the occurrence of the sheet-out error. The OS uses a notifying function called a toast notification, which is the function of the OS, to cause the display unit 119 to display a message. When the user presses this toast notification, the notifying unit 211 of the extension application 204 is invoked from the OS. Then, a UI screen of the notifying unit 211 is displayed. It is possible to display on the UI screen of the notifying unit 211, for example, a detailed message about the sheet-out error or a sheet filling method, etc. It should be noted that once the extension application 204 has transmitted the print data to the printing apparatus 102, it is not possible to display the screen of a guide or the like associated with the print data in the middle of the processing of one of the print setting screen extending unit 205, the skip control unit 206, the print function extending unit 207, the print data editing unit 208, the notifying unit 211, and the print data editing unit UI display unit 209. In addition, the configuration of the extension application 204 for realizing the first embodiment is not limited to a configuration that includes all of the functions (the units) described above. The extension application 204 for realizing the first embodiment may include only some of the functions (the units) described above or may also include other function(s). In addition, the extension application 204 may be simply referred to as “printing software”. As described above, the extension application 204 may include at least one of the print setting screen extending unit 205, the skip control unit 206, and the print function extending unit 207. In addition, the extension application 204 may include at least one of the print data editing unit 208, the print data editing unit UI display unit 209, and the notifying unit 211.

### Adding borderless printing function to print function information by print function extending unit

Among inkjet printers and laser beam printers, there are printing apparatuses 102 that are capable of performing borderless printing. In general, when the printing apparatus 102 arranges (lays out) image data included in the print data on a sheet (a paper sheet), the printing apparatus 102 arranges (lays out) the image data with a predetermined margin from the edge of the sheet (the paper sheet). The printing apparatus 102 prints the arranged image data (the laid-out image data). On the other hand, borderless printing is a function in which the printing apparatus 102 arranges (lays out) and prints image data so that no borders are generated on a sheet on which the image data is printed. In other words, in borderless printing, the printing apparatus 102 sets a predetermined margin from the edge of the sheet to 0, and performs printing without margins. Furthermore, in the case where an extension amount for borderless printing has been designated in the printing apparatus 102, the printing apparatus 102 performs printing with negative margins. The printing apparatus 102 ejects ink in a manner that extends beyond the sheet. As a result, the printing apparatus 102 performs control so that borderless printing is capable of being achieved regardless of the conveyance accuracy of each printing apparatus 102. Borderless printing is a function that is also available in vendor-specific printer drivers. There is also a known case where borderless printing is achieved by the printing apparatus 102 printing image data that has been enlarged in advance by the host computer 101 to a size larger than the size of the sheet (a sheet size).

On the other hand, in the case where borderless printing is performed with the print data generation software 202 and the extension application 204 and by using the IPP protocol, the printing apparatus 102 prints the received image data with a negative margin corresponding to a predetermined extension amount for borderless printing. In other words, the printing apparatus 102 achieves borderless printing by enlarging the received image data by the extension amount for borderless printing and printing the enlarged image data.

### Flow for operation of adding borderless printing function to the print function information 203

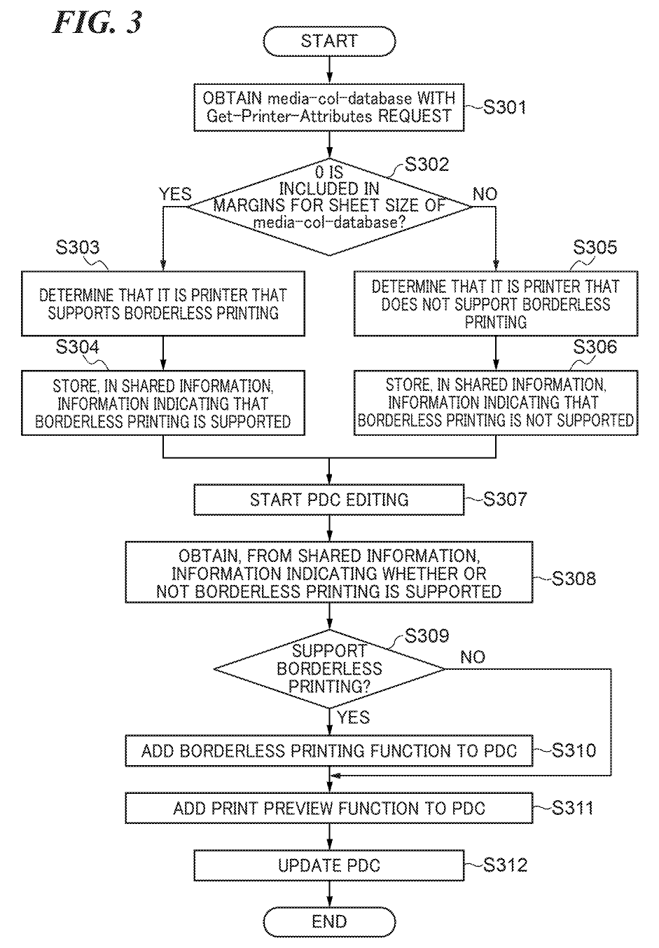

The flow of adding a borderless printing function to the print function information 203 by the print function extending unit 207 of the extension application 204 will be described with reference to FIG. 3. The processing flow of FIG. 3 is started when a print queue that has been associated with the extension application 204 is selected by the user. By selecting the print queue, one of the units included in the extension application 204 is started up. It should be noted that the OS may directly start up the extension application 204, regardless of whether the user starts up the extension application 204 at will.

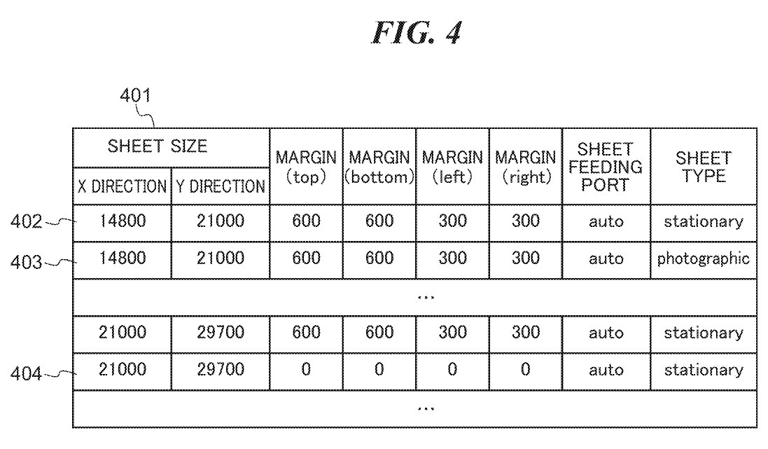

As shown in FIG. 3, in a step S301, the print function extending unit 207 of the extension application 204 obtains capability information from the printing apparatus 102. The print function extending unit 207 issues a “Get-Printer-Attributes” operation of the Internet Printing Protocol (the IPP) to the printing apparatus 102. As a result, the print function extending unit 207 obtains the capability information as a response from the printing apparatus 102. There are a plurality of pieces of attribute data that are capable of being obtained as the response from the printing apparatus 102. In the first embodiment, the print function extending unit 207 obtains, as an example, a media-col-database attribute value as the attribute data. The media-col-database attribute value describes detailed information about sheet settings that are capable of being printed by the printing apparatus 102. An example of information returned by the printing apparatus 102 by using the media-col-database attribute value will be described with reference to FIG. 4.

A sheet information list 401 shown in FIG. 4 is a schematic list representation of part of the attribute data relating to printable sheet information returned by the printing apparatus 102 by using the media-col-database attribute value. In the sheet information list 401, respective pieces of information about a sheet size in an X direction, a sheet size in a Y direction, margin sizes (margins) on the top, bottom, left, and right of a sheet, a sheet feeding port where sheets can be loaded, and a sheet type are represented as a set. It should be noted that in the present disclosure, the top of the margin (Top) corresponds to the leading edge of the printing apparatus 102 in a sheet passing direction.

The sheet information will be specifically described by using a row 402 of the sheet information list 401. It should be noted that in the first embodiment, a unit used to indicate the size information is 1/100th of a millimeter.

The row 402 is sheet information indicating one kind of combination among combinations of the sheet settings that are capable of being printed by the printing apparatus 102. In other words, the row 402 indicates that the sheet size is 14800 in width and 21000 in height, and that the top, bottom, left, and right margins for the sheet size are 600, 600, 300, and 300, respectively. Furthermore, the row 402 indicates that the sheet feeding port is “auto”, and that the sheet type is “stationary”. The sheet setting shown in the row 402 indicates that the printing apparatus 102 is capable of performing printing with the sheet setting of the one kind of combination shown in the row 402. Similarly, a row 403 indicates that the sheet size is 14800 in width and 21000 in height, and that the top, bottom, left, and right margins for the sheet size are 600, 600, 300, and 300, respectively. Furthermore, the row 403 indicates that the sheet feeding port is “auto”, and that the sheet type is “photographic”. The sheet setting shown in the row 403 indicates that the printing apparatus 102 is capable of performing printing with the sheet setting of the combination shown in the row 403. In the combination of the printable sheet setting shown in the row 402 and the combination of the printable sheet setting shown in the row 403, there are margins on all four corners of the sheet. Therefore, the combination of the sheet setting shown in the row 402 and the combination of the sheet setting shown in the row 403 are examples indicating that bordered printing is possible.

On the other hand, a row 404 indicates that the sheet size is 21000 in width and 29700 in height, and that the top, bottom, left, and right margins for the sheet size are 0, 0, 0, and 0, respectively. Furthermore, the row 404 indicates that the sheet feeding port is “auto”, and that the sheet type is “photographic”. The sheet setting shown in the row 404 indicates that the printing apparatus 102 is capable of performing printing with the sheet setting of the combination shown in the row 404. In other words, the combination of the printable sheet setting shown in the row 404 is an example of the combination of the sheet setting indicating that borderless printing is possible.

In the step S301 of FIG. 3, the print function extending unit 207 obtains the sheet information indicated in the sheet information list 401 of FIG. 4. After that, the processing proceeds to a step S302.

In the step S302, the print function extending unit 207 checks a list of the combinations of the printable sheet settings that have been obtained from the media-col-database attribute value. The print function extending unit 207 determines whether or not there is a combination of the printable sheet setting in which the top, bottom, left, and right margins are 0. In the case where there is a combination of the printable sheet setting in which the top, bottom, left, and right margins are 0 (YES in the step S302), the processing proceeds to a step S303. On the other hand, in the case where there is no combination of the printable sheet setting in which the top, bottom, left, and right margins are 0 (NO in the step S302), the processing proceeds to a step S305.

In the step S303, the print function extending unit 207 determines that the connected printing apparatus 102 is a printing apparatus 102 that supports borderless printing. After that, the processing proceeds to a step S304.

In the step S304, the print function extending unit 207 stores, in the shared information 210, information indicating that the connected printing apparatus 102 supports borderless printing. After that, the processing proceeds to a step S307.

In the step S305, the print function extending unit 207 determines that the connected printing apparatus 102 is a printing apparatus 102 that does not support borderless printing. After that, the processing proceeds to a step S306.

In the step S306, the print function extending unit 207 stores, in the shared information 210, information indicating that the connected printing apparatus 102 does not support borderless printing. After that, the processing proceeds to the step S307.

It should be noted that in the first embodiment, the print function extending unit 207 stores the name of the connected printing apparatus 102 and the information indicating whether or not borderless printing is supported, in a manner of associating them with each other. In addition, the print function extending unit 207 may store other information in the shared information 210. For example, the print function extending unit 207 may store, in the shared information 210, a list of sheet size and margin combinations that are capable of being printed by the printing apparatus 102. Furthermore, the print function extending unit 207 may also associate and store other information in the shared information 210. For example, the print function extending unit 207 may associate and store the connection type of the printing apparatus 102, the type of the printing apparatus 102 (e.g., an inkjet printer, a laser printer, or the like), and the like. In addition, the print function extending unit 207 may associate and store information about the printable sheet sizes and sheet types of the printing apparatus 102, as well as information about print functions other than functions related to available sheets.

In the step S307, the print function extending unit 207 obtains the print function information 203. Then, the print function extending unit 207 starts the processing of editing the print function information. After that, the processing proceeds to a step S308.

In the step S308, the print function extending unit 207 obtains, from the shared information 210, the information indicating whether or not the printing apparatus 102 supports borderless printing. After that, the processing proceeds to a step S309.

In the step S309, the print function extending unit 207 determines whether or not the connected printing apparatus 102 supports borderless printing based on the information that has been obtained from the shared information 210. In the case where the connected printing apparatus 102 supports borderless printing (YES in the step S309), the processing proceeds to a step S310. On the other hand, in the case where the connected printing apparatus 102 does not support borderless printing (NO in the step S309), the print function extending unit 207 does not add the borderless printing function to the print function information 203. After that, the processing proceeds to a step S311.

In the step S310, the print function extending unit 207 edits the obtained print function information 203. The print function extending unit 207 adds the borderless printing function to the print function information 203. After that, the processing proceeds to the step S311.

In the step S311, the print function extending unit 207 adds a print preview function to the print function information 203. In the first embodiment, the print preview function is a function that is displayed before printing starts and before the print data is transmitted by the extension application 204 to the printing apparatus 102. This print preview function allows the user to confirm (check) in advance the selected print setting and the image data reflecting the selected print setting on the display unit 119 of the host computer 101. The user is able to confirm (check) the selected print setting and the image data reflecting the selected print setting and then choose whether or not to execute printing. After that, the processing proceeds to a step S312. In the step S312, the print function extending unit 207 updates the print function information 203. As a result of the processing performed by the print function extending unit 207 described above, in the case where the connected printing apparatus 102 supports borderless printing, the borderless printing function and the print preview function become available.

### Example of screen displayed by print setting screen extending unit

Next, a print setting screen, which is displayed by the print setting screen extending unit 205 and allows the use of the borderless printing function and the print preview function, will be described with reference to FIG. 5A.

The PC is generated based on the print function information 203 that has been edited by the print function extending unit 207. In the first embodiment, a print setting screen 501 is displayed based on the PC, which has been generated based on the print function information 203 that has been edited and updated by the print function extending unit 207 in accordance with the processing flow of FIG. 3. In the step S310 and the step S311 that have been described above, the borderless printing function and the print preview function have been added by the print function extending unit 207. As a result, the user becomes able to select the borderless printing function and the print preview function on the print setting screen 501 shown in FIG. 5A, which is displayed by the print setting screen extending unit 205.

The print setting screen extending unit 205 is invoked and started up by the OS when the user instructs, on the rendering application 201, the display of the print setting screen. The print setting screen extending unit 205 displays a screen on which the user is able to designate setting values of print functions that are capable of being designated based on the PC that is capable of being obtained from the OS. As shown in FIG. 5A, a control 502 is a control item, with which the sheet size to be used for printing is capable of being set. With the control 502, an item such as “A4” or “letter” is capable of being set. A control 503 is a control item, with which a print orientation is capable of being set. With the control 503, “portrait” or “landscape” is capable of being set. A control 504 is a control item that allows to select whether or not to print a borderless image when printing an image onto a printing sheet (a printing paper sheet). The control 504 is an example of a first object, and the step of displaying the control 504 is an example of a first display control step. A control 505 is a control item that allows to select whether or not to display a print preview before executing printing. A control 506 is a cancel button. The control 506 is used to close the screen without reflecting the setting. A control 507 is an OK button. The control 507 is used to close the screen after reflecting the setting. In the first embodiment, the print setting screen extending unit 205 displays a screen indicating that the sheet size is set to “A4”, the print orientation is set to “portrait”, borderless printing is set to “ON”, and print preview display is set to “ON”. In the case where the above-described print functions and other print functions have been selected by the user and the OK button indicated by the control 507 has been pressed by the user, the print setting screen extending unit 205 reflects the selected print functions to the PT. As a result, the processing performed by the print setting screen extending unit 205 ends.

### PT 600 in state where print functions have been reflected

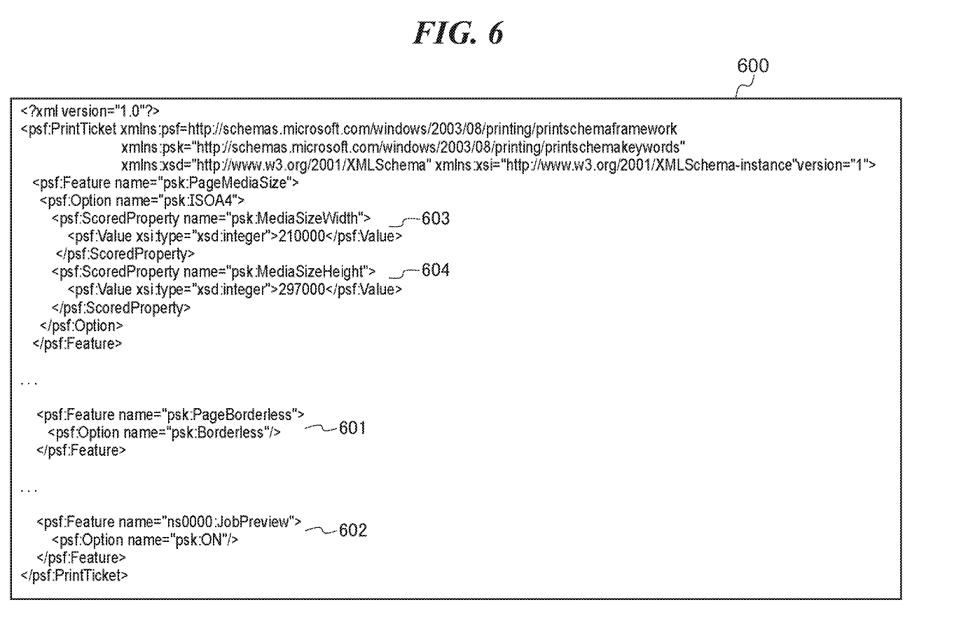

FIG. 6 shows an example of a PT 600 in a state where the above-described print functions have been reflected by the print setting screen extending unit 205. As shown in FIG. 6, in a function 601, Feature name is “PageBorderless”, and Option name is “Borderless”. In other words, the PT 600 has been updated to a PT in a state where the borderless printing function has been enabled as an option of the borderless printing function. In addition, in a function 602, Feature name is “JobPreview”, and Option name is “ON”. In other words, the PT 600 has been updated to a PT in a state where the print preview display is turned on as an option of the print preview function. In this way, in the case where the user has selected the borderless printing function and the print preview function through the print setting screen extending unit 205, the print setting screen extending unit 205 updates the PT. The print setting screen extending unit 205 makes, to the PT, a change of enabling the borderless printing function and turning on the print preview display. The PT that has been updated by the print setting screen extending unit 205 is subsequently used in the processing of editing the print data, which is performed by the print data editing unit 208.

### Flow for operation of displaying print preview by print data editing unit UI display unit

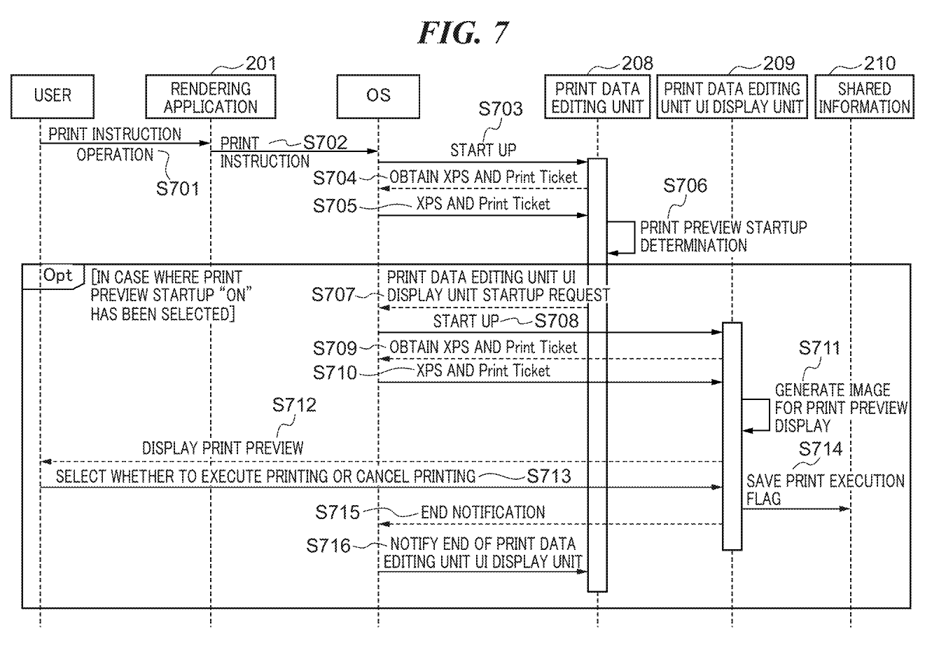

Next, a sequence, in which the print data editing unit UI display unit 209 is started up from the print data editing unit 208 and a print preview is displayed, will be described with reference to FIG. 7.

In the first embodiment, as a result of the user selecting the borderless printing function and the print preview function on the print setting screen extending unit 205, the borderless printing function is enabled. As a result, the PT is updated to the state where the print preview display is turned on. The PT is transmitted from the rendering application 201 to the print data editing unit 208 along with the intermediate data. In addition, in the first embodiment, the processing of the print data generation software 202 is skipped. The intermediate data and the PT are transmitted directly to the print data editing unit 208 of the extension application 204.

As shown in FIG. 7, in a step S701, the user executes a print instruction operation of the rendering data that has been created by the rendering application 201, with respect to the rendering application 201 via the display unit 119.

In a step S702, the rendering application 201 executes (issues) a print instruction to the OS, based on the print instruction operation from the user.

In a step S703, the OS starts up the print data editing unit 208 of the extension application 204, based on the print instruction from the rendering application 201.

In a step S704, the print data editing unit 208 that has been started up requests the intermediate data and the PT from the OS.

In a step S705, the OS transmits, to the print data editing unit 208, XPS format data as the intermediate data that has been requested by the print data editing unit 208. Furthermore, the OS transmits, to the print data editing unit 208, the PT that has reflected the content of the print instruction (hereinafter, referred to as “the print instruction content”).

Next, in a step S706, the print data editing unit 208 performs a print preview startup determination based on the print instruction content that has been described in the obtained PT. In the first embodiment, the print data editing unit 208 determines whether or not “JobPreview” exists in the Feature of the obtained PT 600. In addition, the print data editing unit 208 determines whether or not the Option that has been set in the Feature of “JobPreview” is “ON”. In the obtained PT 600 (see FIG. 6), “JobPreview” exists in the Feature, and the Option has been set to “ON”. Therefore, the print data editing unit 208 determines to perform the print preview display.

In a step S707, the print data editing unit 208 requests the OS to start up the print data editing unit UI display unit 209 in order to display a print preview. In a step S708, the OS starts up the print data editing unit UI display unit 209 based on the UI startup request from the print data editing unit 208. The print data editing unit UI display unit 209 is started up by the OS and starts the processing. Then, in a step S709, the print data editing unit UI display unit 209 requests the intermediate data and the PT from the OS.

In a step S710, the OS transmits, to the print data editing unit UI display unit 209, XPS format data as the intermediate data that has been requested by the print data editing unit UI display unit 209, and the PT in which the print instruction content has been described. The XPS format data transmitted from the OS to the print data editing unit UI display unit 209 is the same as the XPS format data (XPS data) obtained from the OS by the print data editing unit 208 in the step S705.

When the print data editing unit UI display unit 209 obtains the XPS format data (XPS data) from the OS, in a step S711, the print data editing unit UI display unit 209 generates an image for print preview display. The processing for generating the image for print preview display by the print data editing unit UI display unit 209 will be described below.

Next, in a step S712, the print data editing unit UI display unit 209 displays a print preview to the user via the display unit 119.

### Display of print preview

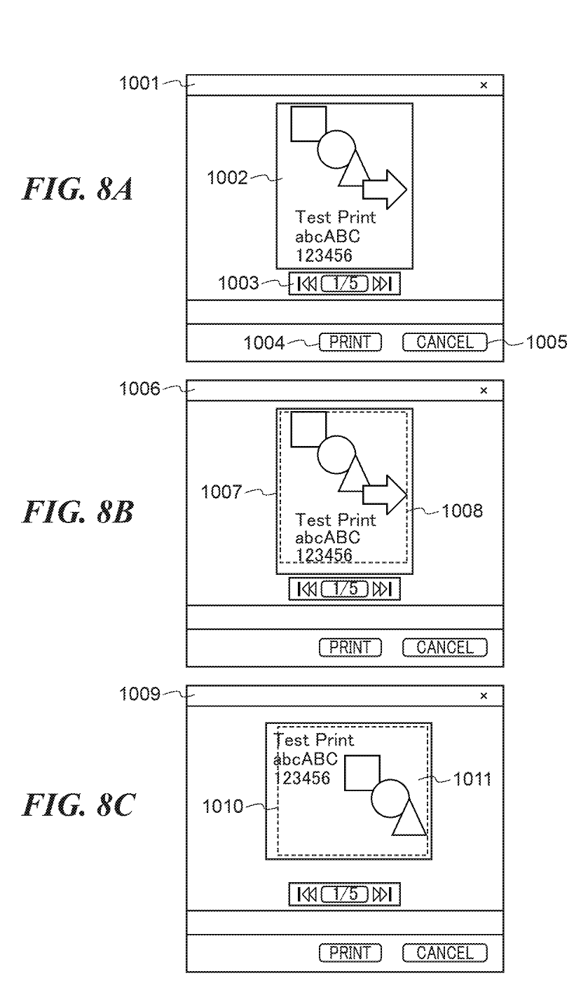

The print preview displayed on the display unit 119 by the print data editing unit UI display unit 209 will be described with reference to FIGS. 8A, 8B, and 8C.

A print preview screen 1001 shown in FIG. 8A displays an image for print preview on a print preview image display area 1002 based on the intermediate data that has been obtained from the OS. In addition, the print preview screen 1001 includes a control 1003 for performing page transition in a multi-page print job. In the first embodiment, the control 1003 includes a page-turning button for performing page transition for each page, and page transition buttons for transitioning to the first page and the last page. Furthermore, the control 1003 includes a text box for page designation which allows to transition to any page. A control 1004 is a print button. A control 1005 is a cancel button. When the controls 1003 to 1005 are pressed by the user, the extension application 204 stores the result of the press in the shared information 210. When the control 1004 or the control 1005 is pressed, the print data editing unit UI display unit 209 terminates the print preview screen display. It should be noted that the print preview screen 1001 is an example of a print preview screen that is displayed in the case where borderless printing has not been enabled.

In a step S713 of FIG. 7, the user confirms (checks) the content of the print preview that has been displayed on the display unit 119. The user chooses whether to execute printing or cancel printing. In other words, the user presses either the print button indicated by the control 1004 or the cancel button indicated by the control 1005 on the print preview screen 1001 that has been described above.

In response to the instruction selected by the user, in a step S714, the print data editing unit UI display unit 209 stores, in the shared information 210, a print execution flag indicating whether to execute printing or cancel printing. Subsequently, in a step S715, the print data editing unit UI display unit 209 notifies the OS of the termination of the print data editing unit UI display unit 209. As a result, the processing in the sequence shown in FIG. 7 ends.

In a step S716, the OS receives a termination notification from the print data editing unit UI display unit 209 and notifies the print data editing unit 208 of the termination of the print data editing unit UI display unit 209. After that, the OS returns the processing to the print data editing unit 208.

### Generating image for print preview when borderless printing is enabled

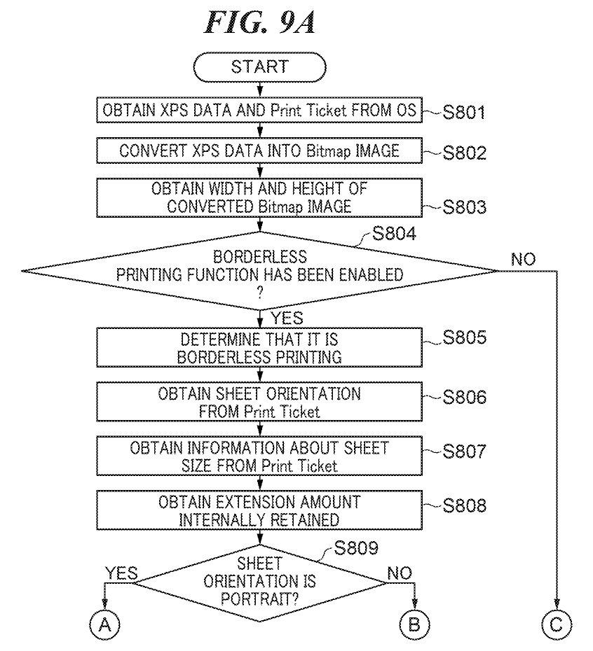

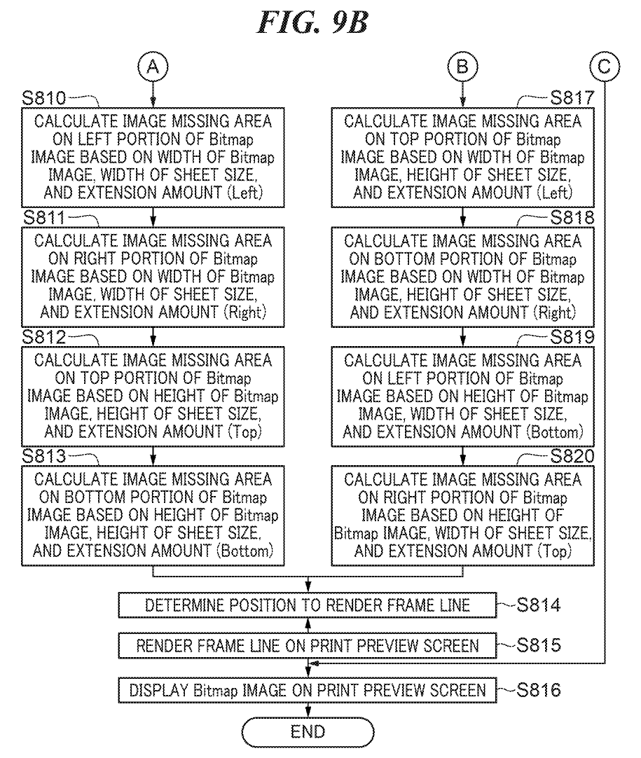

As described above, in the case where borderless printing is performed with the print data generation software 202 and the extension application 204 and by using the IPP protocol, the printing apparatus 102, upon receiving the print data, enlarges the image based on the predetermined extension amount and prints the enlarged image. On the other hand, a print preview image to be generated by the print data editing unit UI display unit 209 is generated based on the XPS data that has been obtained from the rendering application 201. This print preview image does not take into account the enlargement processing performed by the printing apparatus 102. Therefore, the print preview image generated by the print data editing unit UI display unit 209 includes portions that will extend beyond the sheet (the printing sheet) and not be printed during actual printing due to the enlargement by the printing apparatus 102. For the user, even after confirming (checking) the print result by the print preview before printing, unintended image missing may occur in the actual printout (the actual print result). Therefore, in some cases, this could lead to misprints. In order to deal with the above issue, in the first embodiment, in the case where the borderless printing function has been enabled, the processing of generating an image for print preview performed by the print data editing unit UI display unit 209 will be described with reference to FIGS. 9A and 9B(hereinafter, FIGS. 9A and 9B are simply referred to as FIG. 9).

It should be noted that the processing shown in FIG. 9 corresponds to the processing performed by the print data editing unit UI display unit 209 after the processing of the step S708 shown in FIG. 7. In other words, the processing shown in FIG. 9 corresponds to the processing after the OS starts up the print data editing unit UI display unit 209 in response to the request from the print data editing unit 208.

As shown in FIG. 9, first, in a step S801, the print data editing unit UI display unit 209 obtains the XPS data and the PT from the OS. After that, the processing proceeds to a step S802.

In the step S802, the print data editing unit UI display unit 209 converts the obtained XPS data into Bitmap image format (a Bitmap image). As a result, the print data editing unit UI display unit 209 becomes capable of displaying the converted Bitmap image as a print preview on the display unit 119. After that, the processing proceeds to a step S803.

In the step S803, the print data editing unit UI display unit 209 obtains the size of the converted Bitmap image, that is, a width and a height of the converted Bitmap image. After that, the processing proceeds to a step S804.

In the step S804, the print data editing unit UI display unit 209 checks a setting value for the borderless printing function, which is included in the PT. The print data editing unit UI display unit 209 determines whether or not the borderless printing function has been enabled. Specifically, the print data editing unit UI display unit 209 determines whether or not as a Feature,“PageBorderless” exists within the PT. Furthermore, the print data editing unit UI display unit 209 determines whether or not “Borderless” has been selected as an Option for the Feature. In the case where the borderless printing function has been enabled (YES in the step S804), the processing proceeds to a step S805. On the other hand, in the case where the borderless printing function has not been enabled (NO in the step S804), the processing proceeds to a step S816.

In the step S805, the print data editing unit UI display unit 209 determines that the print instruction, which is the target of the print preview, is borderless printing. After that, the processing proceeds to a step S806.

In the step S806, the print data editing unit UI display unit 209 obtains, from the PT, sheet orientation information indicating whether an orientation of the sheet (a sheet orientation) is “portrait” or “landscape”. Next, in a step S807, the print data editing unit UI display unit 209 obtains, from the PT, information about the sheet size. In the first embodiment, the information about the sheet size is “MediaSizeWidth” 603 and “MediaSizeHeight” 604 that have been defined in the PT 600 (see FIG. 6). In other words, in the step S807, the print data editing unit UI display unit 209 obtains 210000, which has been defined in the “MediaSizeWidth” 603 of the PT 600, for the sheet size width. In addition, the print data editing unit UI display unit 209 obtains 297000, which has been defined in the “MediaSizeHeight” 604 of the PT 600, for the sheet size height. After that, the processing proceeds to a step S808.

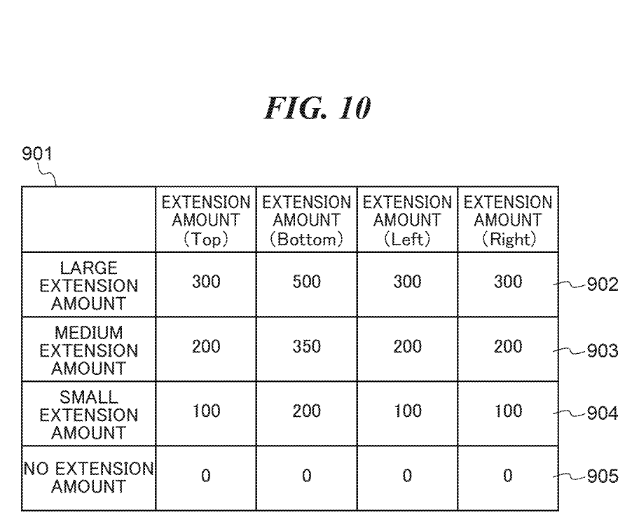

In the step S808, the print data editing unit UI display unit 209 obtains borderless printing extension amount information of the printing apparatus 102 that is retained in the inside of the extension application 204. It should be noted that “the inside of the extension application 204” may refer to “within the execution program of the extension application 204 itself”, or “the shared information 210”. Alternatively, the borderless printing extension amount information may be saved (stored) on a server or the like that is located the outside of the extension application 204. The extension application 204 may retain information for accessing the server where the borderless printing extension amount information has been saved (stored). Here, an example of the borderless printing extension amount information that the printing apparatus 102 has will be described with reference to FIG. 10. FIG. 10 illustrates an extension amount list 901 that indicates a list of settable values for borderless printing extension amount in a certain printing apparatus 102. In the printing apparatus 102 that has borderless printing extension amounts shown in FIG. 9, the user is able to select a desired borderless printing extension amount. A case in which “large borderless printing extension amount” indicated by a row 902 of the extension amount list 901 is selected will be described. The printing apparatus 102 enlarges the image in accordance with an extension amount of 300 in the Top, Left, and Right directions, and an extension amount of 500 in the Bottom direction, with respect to the image data of the received print data. As a result, the missing of the image data will become large. Instead, it can be guaranteed that borders do not occur as much as possible. Similarly, a case in which “medium borderless printing extension amount” indicated by a row 903 of the extension amount list 901 is selected will be described. The printing apparatus 102 enlarges the image in accordance with an extension amount of 200 in the Top, Left, and Right directions of the received image data, and an extension amount of 350 in the Bottom direction of the received image data. In addition, a case in which “small borderless printing extension amount” indicated by a row 904 of the extension amount list 901 is selected will be described. The printing apparatus 102 enlarges the image in accordance with an extension amount of 100 in the Top, Left, and Right directions of the received image data, and an extension amount of 200 in the Bottom direction of the received image data.

The smaller the settable value for borderless printing extension amount shown in the extension amount list, the less the missing of the image data, but the higher the possibility of borders occurring. In addition, in the case where “no borderless printing extension amount” indicated by a row 905 of the extension amount list 901 has been selected, the printing apparatus 102 does not enlarge the image with respect to the received image data. In the case where the “no borderless printing extension amount” indicated by the row 905 of the extension amount list 901 has been selected, it can be said that borders will occur in most cases. It can be said that the setting of the “no borderless printing extension amount” is an effective setting, for example, in a case of wanting to print the portion near the borders when printing the address side of a postcard. Thus, in terms of the borderless printing extension amounts that the printing apparatus 102 has, it can be said that there is a trade-off relationship between the possibility of borders occurring during borderless printing and the area in which image missing occurs.

In the first embodiment, the borderless printing extension amounts of the “large borderless printing extension amount” in the printing apparatus 102 are internally retained by the extension application 204. The borderless printing extension amounts are used when generating the print preview image. The “large borderless printing extension amount” is likely to result in an unexpected print result for the user due to the missing of the image data, and is therefore considered to have the greatest disadvantage for the user. By adopting the configuration of the first embodiment, the user is able to recognize that the borderless printing extension amounts that the printing apparatus 102 has may result in an unexpected print result. In addition, in that case, the user is able to choose to cancel printing on the print preview screen. As a result, the user is capable of taking an action, such as desisting from printing, or changing the print setting and performing printing again.

In the step S808 of FIG. 9, the print data editing unit UI display unit 209 obtains the borderless printing extension amount information retained within the extension application 204 itself. After that, the processing proceeds to a step S809.

In the step S809, the print data editing unit UI display unit 209 refers to the sheet orientation information that has been obtained from the PT. The print data editing unit UI display unit 209 determines whether the sheet orientation is “portrait” or “landscape”. In the present disclosure, the sheet orientation being “portrait” refers to a so-called portrait direction, and the sheet orientation being “landscape” refers to a so-called landscape direction. In the case where the sheet orientation is “portrait” (YES in the step S809), the processing proceeds to a step S810. On the other hand, in the case where the sheet orientation is “landscape” (NO in the step S809), the processing proceeds to a step S817.

In the step S810, the print data editing unit UI display unit 209 calculates the number of pixels (hereinafter, referred to as “a pixel count”) in an image missing area on the left portion of the Bitmap image based on the width of the Bitmap image, the width of the sheet size, and the borderless printing extension amount in the Left direction. The image missing area on the left portion of the Bitmap image is an area where image missing occurs during printing by the printing apparatus 102. The print data editing unit UI display unit 209 obtains (calculates) a ratio of the borderless printing extension amount in the Left direction to the width of the sheet size. The print data editing unit UI display unit 209 calculates the number of pixels (a pixel count) occupied by the borderless printing extension amount on the Bitmap image by multiplying the width of the Bitmap image by the obtained ratio.

Next, in a step S811, the print data editing unit UI display unit 209 calculates the number of pixels (a pixel count) in an image missing area on the right portion of the Bitmap image based on the width of the Bitmap image, the width of the sheet size, and the borderless printing extension amount in the Right direction. The image missing area on the right portion of the Bitmap image is an area where image missing occurs during printing by the printing apparatus 102.

Next, in a step S812, the print data editing unit UI display unit 209 calculates the number of pixels (a pixel count) in an image missing area on the top portion of the Bitmap image based on the height of the Bitmap image, the height of the sheet size, and the borderless printing extension amount in the Top direction. The image missing area on the top portion of the Bitmap image is an area where image missing occurs during printing by the printing apparatus 102.

Next, in a step S813, the print data editing unit UI display unit 209 calculates the number of pixels (a pixel count) in an image missing area on the bottom portion of the Bitmap image based on the height of the Bitmap image, the height of the sheet size, and the borderless printing extension amount in the Bottom direction. The image missing area on the bottom portion of the Bitmap image is an area where image missing occurs during printing by the printing apparatus 102.

Next, in a step S814, the print data editing unit UI display unit 209 determines a position for rendering a frame line for representing the area where image missing occurs. The print data editing unit UI display unit 209 determines the position for rendering the frame line, based on the number of pixels (the pixel counts) in the image missing areas on the Bitmap image that have been calculated in the steps S810 to S813, that is, based on the number of pixels (the pixel count) in the image missing area on the left portion of the Bitmap image that has been calculated in the step S810, the number of pixels (the pixel count) in the image missing area on the right portion of the Bitmap image that has been calculated in the step S811, the number of pixels (the pixel count) in the image missing area on the top portion of the Bitmap image that has been calculated in the step S812, and the number of pixels (the pixel count) in the image missing area on the bottom portion of the Bitmap image that has been calculated in the step S813.

Next, in a step S815, the print data editing unit UI display unit 209 renders the frame line on the print preview screen. Next, in the step S816, the print data editing unit UI display unit 209 displays the Bitmap image for print preview display on the print preview screen. The step S815 and the step S816 are an example of a second display control step.

In the first embodiment, in this way, the print data editing unit UI display unit 209 displays the Bitmap image for print preview display on the print preview screen. In addition, the print data editing unit UI display unit 209 renders the frame line for representing the area where image missing occurs when performing borderless printing. As a result, the print data editing unit UI display unit 209 become capable of representing, on the print preview screen, the area where image missing occurs during printing by the printing apparatus 102.

### Print preview screen in case where borderless printing function has been enabled

A print preview screen displayed by the print data editing unit UI display unit 209 in the case where the borderless printing function has been enabled will be described with reference to FIG. 8B. A print preview screen 1006 shown in FIG. 8B is an example of a screen on which the Bitmap image for print preview and the frame line for representing the area where image missing occurs are displayed by superimposing. With a frame line for image missing area display (an image missing area display frame line) 1008, the area where image missing occurs during printing that has been calculated by the print data editing unit UI display unit 209 is represented as an area that is based on the number of pixels on the Bitmap. The number of pixels is the values that have been calculated by the print data editing unit UI display unit 209 in the steps S810 to S813 of FIG. 9. In other words, a Bitmap image portion (a Bitmap image area) outside a frame indicated by the image missing area display frame line 1008 indicates that this is the area where image missing occurs. The Bitmap image portion outside the frame indicated by the image missing area display frame line 1008 is an area generated due to the enlargement and printing of the image performed by the printing apparatus 102 based on the borderless printing extension amounts during borderless printing. It should be noted that in the first embodiment, the frame line indicating the image missing area is rendered with a dotted line, but the method for indicating the image missing area may be any another method. For example, a rectangle that covers the Bitmap image portion corresponding to the calculated image missing area may be rendered so that the area where image missing occurs during printing will not be displayed on the print preview screen.

It should be noted that the borderless printing extension amounts that the printing apparatus 102 has, which are shown in FIG. 10, are extension amounts in the Top, Bottom, Left, and Right directions in the case where the sheet orientation is “portrait”. In the case of a general inkjet printer or the like, the sheet (the printing sheet) is often sheet-passed in the portrait direction. In the present disclosure, it is assumed that the sheet (the printing sheet) is always sheet-passed in the portrait direction. In this case (under this assumption), in the case where the sheet orientation is set to “landscape” and the print preview is displayed, it is necessary to consider rotating the value of the borderless printing extension amount by 90 degrees. In other words, in the case where the sheet orientation is set to “landscape”, a margin in the Right direction needs to be applied to the top portion of the print preview image. A margin in the Left direction needs to be applied to the bottom portion of the print preview image. A margin in the Bottom direction needs to be applied to the left portion of the print preview image. A margin in the Top direction needs to be applied to the right portion of the print preview image.

In the step S817, the print data editing unit UI display unit 209 calculates the number of pixels (a pixel count) in an image missing area on the top portion of the Bitmap image based on the width of the Bitmap image, the height of the sheet size, and the borderless printing extension amount in the Left direction. The image missing area on the top portion of the Bitmap image is an area where image missing occurs during printing.

Next, in a step S818, the print data editing unit UI display unit 209 calculates the number of pixels (a pixel count) in an image missing area on the bottom portion of the Bitmap image based on the width of the Bitmap image, the height of the sheet size, and the borderless printing extension amount in the Right direction. The image missing area on the bottom portion of the Bitmap image is an area where image missing occurs.

Next, in a step S819, the print data editing unit UI display unit 209 calculates the number of pixels (a pixel count) in an image missing area on the left portion of the Bitmap image based on the height of the Bitmap image, the width of the sheet size, and the borderless printing extension amount in the Bottom direction. The image missing area on the left portion of the Bitmap image is an area where image missing occurs.

Next, in a step S820, the print data editing unit UI display unit 209 calculates the number of pixels (a pixel count) in an image missing area on the right portion of the Bitmap image based on the height of the Bitmap image, the width of the sheet size, and the borderless printing extension amount in the Top direction. The image missing area on the right portion of the Bitmap image is an area where image missing occurs. Next, the processing proceeds to the step S814. The processes performed in the steps S814 to S816 are the same as the processing details that have been described above, so description thereof is omitted.

### In case where sheet orientation is “landscape”

A print preview screen 1009 displayed by the print data editing unit UI display unit 209 in the case where the borderless printing function has been enabled and the sheet orientation is set to “landscape” will be described with reference to FIG. 8C. The print preview screen 1009 shown in FIG. 8C is an example of a screen displayed by the print data editing unit UI display unit 209 after the print data editing unit UI display unit 209 performs the processing shown in FIG. 9. An image missing area display frame line 1011 is a frame line rendered by replacing the area where image missing occurs during printing with the number of pixels on the Bitmap. The image missing area display frame line 1011 is the values that have been calculated by the print data editing unit UI display unit 209 in the steps S817 to S820 of FIG. 9. In FIG. 8C, since the sheet orientation is set to “landscape”, a landscape image is displayed on the print preview image display area. In the case where printing is actually performed by the printing apparatus 102, sheet passing is performed in the portrait direction. The printing apparatus 102 applies the borderless printing extension amounts to the portrait sheet (the sheet located in the portrait direction) to enlarge the image and also perform printing. Therefore, the print data editing unit UI display unit 209 takes into account the borderless printing extension amounts applied during sheet passing, and calculates the image missing area. The print data editing unit UI display unit 209 performs rendering of the image missing area display frame line 1011 on the print preview screen 1009.

The above is an example in which the print function extending unit 207 of the extension application 204 enables the borderless printing function and the print preview function. In addition, the above is an example in which the print preview display when the borderless printing function is enabled is performed by the print data editing unit UI display unit 209 after the functions are selected by the print setting screen extending unit 205. By adopting the method that has been described in the first embodiment, in the print preview of the extension application 204, the area where image missing occurs during actual printing is represented in advance. As a result, it becomes possible to reduce the number of cases in which misprints occur for the user. It should be noted that a method can also be considered in which an image with the image missing area removed is generated by editing the XPS data for pre-print preview display and the pre-print preview display is performed by using the image data that has been edited. In this case, since it is necessary to perform editing of the XPS data by the print data editing unit UI display unit 209, performance degradation will occur. By adopting the method that has been described in the first embodiment, performance degradation due to editing of the XPS data will not occur. As a result, it is also possible to reduce the time and resource consumption required for pre-print preview display.

### Second embodiment

In the first embodiment, the processing in the case where the print preview display when the borderless printing function is enabled is performed by the print data editing unit UI display unit 209 after the borderless printing function is selected by the print setting screen extending unit 205, has been described. However, depending on the user's use case, there may be cases of wanting to rotate an image by 180 degrees and then perform printing. As the most common example, there is a case where the user wants to print the recipient's address on an envelope. Depending on the application used to create the image data or the type of the method for feeding envelope sheets (envelopes) into a printer that performs printing, in some cases, printing the image directly onto an envelope may result in the image being printed upside down on the envelope. In this case, by rotating the image to be printed by 180 degrees and then performing printing, it is possible to perform printing in a correct print orientation for the envelope. The second embodiment is a method proposed in consideration of such a case. The print data editing unit UI display unit 209, when displaying a print preview screen, switches the method for calculating the image missing area, depending on whether or not 180-degree rotation has been selected.

It should be noted that in the second embodiment as well, the image itself is displayed on the print preview screen without being rotated by 180 degrees. As also described in the first embodiment, a method can also be considered in which an image obtained by rotating the image to be printed by 180 degrees is generated by editing the XPS data for print preview display and the print preview display is performed by using the image data that has been edited. However, also in this case, performance degradation due to editing of the XPS data will occur. By adopting the method of the second embodiment, it becomes possible to provide the user with a method to correctly confirm (check) the print result before printing while suppressing performance degradation. It should be noted that the system configuration not specifically mentioned in the following description is the same as that in the first embodiment, and therefore the description is omitted. In addition, the processing flow not specifically mentioned in the following description is the same as that in the first embodiment, and therefore the description is omitted.

### Selecting 180-degree rotation function on print setting screen and starting up print data editing unit

First, in the second embodiment, a print setting screen displayed by the print setting screen extending unit 205, on which a 180-degree rotation function is available, will be described by using a print setting screen 508 shown in FIG. 5B. PC is generated based on print function information (not shown), to which the 180-degree rotation function for the edited and updated image has been added by the print function extending unit 207. In other words, an image 180-degree rotation function is added by the print function extending unit 207 of the extension application 204. As a result, the user becomes able to select these functions on the print setting screen 508 shown in FIG. 5B, which is displayed by the print setting screen extending unit 205. As shown in FIG. 5B, a control 509 is a control item that allows to select whether or not to, when printing an image on a printing sheet, rotate the image by 180 degrees and then perform printing. The control 509 is an example of a third object. The step of displaying the control 509 is an example of a fourth display control step. In the second embodiment, the case in which the image 180-degree rotation function has been selected as “ON” in the control items shown on the print setting screen 508 displayed in the display control step will be described. In addition, the case in which borderless printing has been selected as “ON” and print preview display has been selected as “ON” will be described.

In the case where the above-described print functions and other print functions have been selected by the user and also an OK button on the print setting screen 508 has been pressed by the user, the print setting screen extending unit 205 reflects the selected print functions to the PT. Next, when the user performs a print instruction operation to the rendering application 201, the borderless printing function and the image 180-degree rotation function are enabled. As a result, the PT that has been updated to the state where the print preview display is turned on, along with the intermediate data, is transmitted from the rendering application 201 to the print data editing unit 208. It should be noted that also in the second embodiment, the processing of the print data generation software 202 is skipped. The intermediate data and the PT are transmitted directly to the print data editing unit 208 of the extension application 204. The sequence from when the print data editing unit 208 is started up until the print data editing unit UI display unit 209 is started up is the same as the sequence that has been described with reference to FIG. 7, so description thereof is omitted.

### Generating image for print preview when image 180-degree rotation and borderless printing are enabled

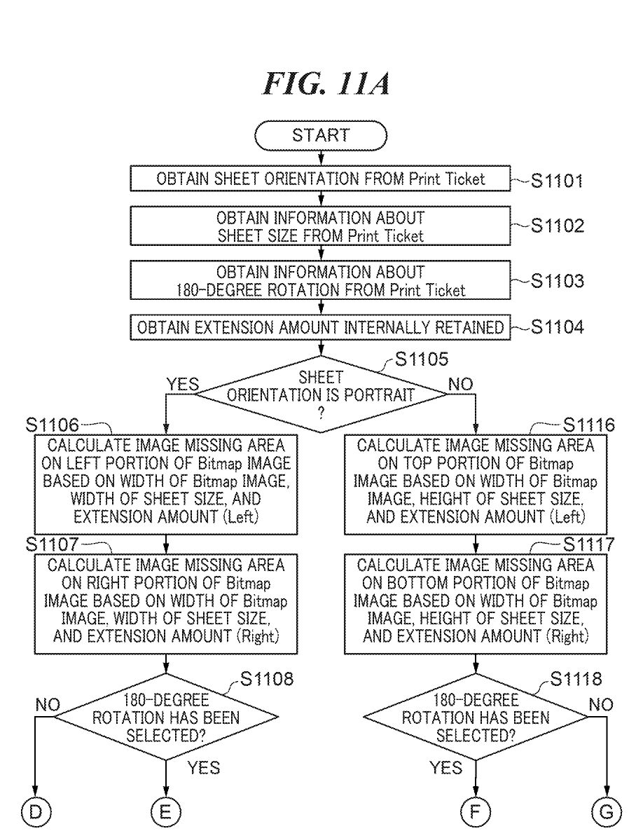

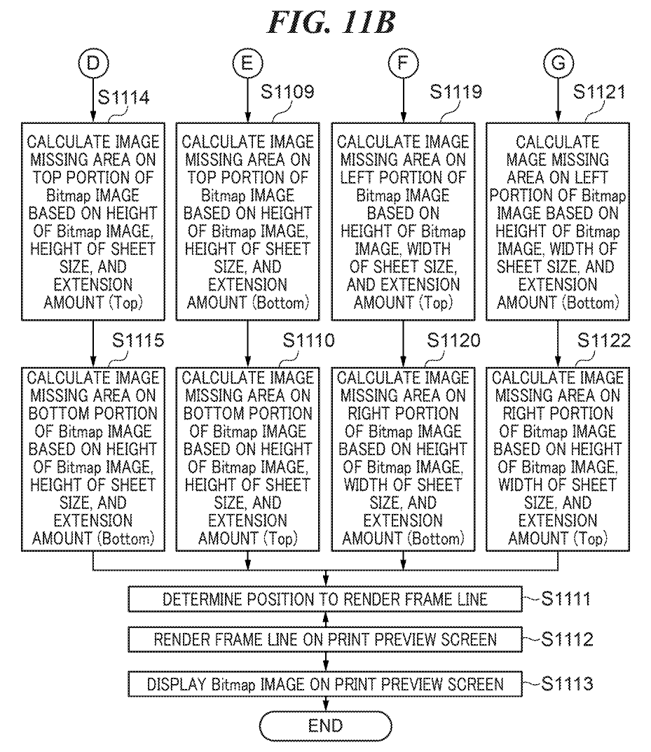

Next, in the case where the image 180-degree rotation function and the borderless printing function have been enabled, the processing of generating an image for print preview performed by the print data editing unit UI display unit 209 will be described with reference to FIGS. 11A and 11B (hereinafter, FIGS. 11A and 11B are simply referred to as FIG. 11). It should be noted that the processing shown in FIG. 11 corresponds to the processing after it is determined that the borderless printing function is enabled. In other words, the processing shown in FIG. 11 corresponds to the processing from the step S801 to the step S805 of FIG. 9 onwards which is performed by the print data editing unit UI display unit 209.

As shown in FIG. 11, Steps S1101 and S1102 are the same processes as the steps S806 and S807 in FIG. 9, so description thereof is omitted.

Next, in a step S1103, the print data editing unit UI display unit 209 obtains, from the PT, information indicating whether or not the image 180-degree rotation function has been enabled (a setting value for the image 180-degree rotation function). After that, the processing proceeds to a step S1104. The process in the step S1104 is the same as the process in the step S808, so description thereof is omitted.

Next, in a step S1105, the print data editing unit UI display unit 209 determines whether or not the sheet orientation is “portrait”. In the case where the sheet orientation is “portrait” (YES in the step S1105), the processing proceeds to a step S1106. On the other hand, in the case where the sheet orientation is not “portrait” (NO in the step S1105), that is, in the case where the sheet orientation is “landscape”, the processing proceeds to a step S1116. The processes in the steps S1116 and S1117 are the same as the processes in the steps S817 and S818 that have been described with reference to FIG. 9, so description thereof is omitted.

The processes in the steps S1106 and S1107 are the same as the processes in the steps S810 and S811 that have been described with reference to FIG. 9, so description thereof is omitted.

Next, in a step S1108, the print data editing unit UI display unit 209 determines whether or not the image 180-degree rotation function has been selected, based on the setting value for the image 180-degree rotation function that has been obtained from the PT. In the case where the image 180-degree rotation function has been selected (YES in the step S1108), the processing proceeds to a step S1109. On the other hand, in the case where the image 180-degree rotation function has not been selected (NO in the step S1108), the processing proceeds to a step S1114. The processes in the steps S1114 and S1115 are the same as the processes in the steps S812 and S813 that have been described with reference to FIG. 9, so description thereof is omitted. It should be noted that in the second embodiment, as shown in FIG. 10, since the extension amount in the Left direction and the extension amount in the Right direction are the same, even in the case where the 180-degree rotation function has been selected, there is no need to exchange the extension amount in the Left direction and the extension amount in the Right direction. Therefore, the print data editing unit UI display unit 209 determines whether or not the 180-degree rotation function has been selected after the steps S1106 and S1107 (the step S1108). However, in the case where the extension amount in the Left direction and the extension amount in the Right direction are different from each other, before the step S1106, the determination in the step S1108 may be performed, and then the extension amount in the Left direction and the extension amount in the Right direction may be exchanged. The same applies to the steps S1116 to S1118 that will be described below.

Next, in the step S1109, the print data editing unit UI display unit 209 calculates the number of pixels (a pixel count) in an image missing area on the top portion of a Bitmap image where image missing occurs during printing by the printing apparatus 102. It should be noted that the calculation of the number of pixels (the pixel count) is performed based on the height of the Bitmap image, the height of the sheet size, and the borderless printing extension amount in the Bottom direction. In the second embodiment, the print data editing unit UI display unit 209 displays the print preview based on an image that is not upside down. The image data obtained from the OS when the print data editing unit UI display unit 209 is started up does not reflect the result of editing performed by the print data editing unit 208. Therefore, the print data editing unit UI display unit 209 itself needs to perform the processing of editing the XPS data. Therefore, as in the process of the step S1109, in the case where the image 180-degree rotation function has been selected, the print data editing unit UI display unit 209 exchanges the extension amount in the Top direction and the extension amount in the bottom direction. The print data editing unit UI display unit 209, when calculating the number of pixels in the image missing area on the Bitmap image, exchanges the extension amount in the Top direction and the extension amount in the bottom direction. As a result, an image missing area in the case where the image is upside down during actual printing is represented.

Next, in a step S1110, the print data editing unit UI display unit 209 calculates the number of pixels (a pixel count) in an image missing area on the bottom portion of the Bitmap image where image missing occurs during printing by the printing apparatus 102. It should be noted that the calculation of the number of pixels (the pixel count) is performed based on the height of the Bitmap image, the height of the sheet size, and the borderless printing extension amount in the Top direction. Next, the processing proceeds to a step S1111. The processes from the steps S1111 to S1113 are the same as the processes from the steps S814 to S816 that have been described with reference to FIG. 9, so description thereof is omitted.

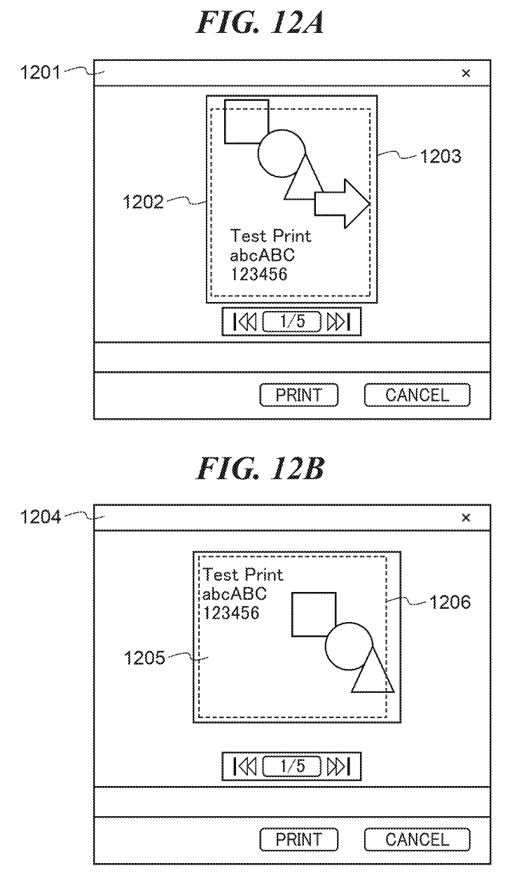

A print preview screen displayed by the print data editing unit UI display unit 209 in the case where the image 180-degree rotation function and the borderless printing function have been enabled, which is generated by the above processing, will be described with reference to FIGS. 12A and 12B.

A print preview screen 1201 shown in FIG. 12A is an example of a screen in the case where the image 180-degree rotation function and the borderless printing function have been enabled. As shown in FIG. 12A, on the print preview screen 1201, the print data editing unit UI display unit 209 displays the Bitmap image for print preview and a frame line for representing the area where image missing occurs during borderless printing by superimposing. In a preview image display area 1202 on the print preview screen 1201, the Bitmap image, which has been generated based on the XPS image data obtained by the print data editing unit UI display unit 209 from the OS, is displayed. Since the XPS image data that forms the basis of the Bitmap image does not reflect the image 180-degree rotation, the same image as in the case where the image 180-degree rotation function has not been enabled is displayed on the preview image display area 1202. On the other hand, an image missing area display frame line 1203, which is calculated based on the processing shown in FIG. 11, correctly displays the image missing area that occurs when the image is rotated by 180 degrees and printed by the printing apparatus 102, by performing the calculation after exchanging the extension amount in the Top direction and the extension amount in the bottom direction.

In the step S1118, the print data editing unit UI display unit 209 determines whether or not the image 180-degree rotation function has been selected, based on the setting value for the image 180-degree rotation function that has been obtained from the PT. In the case where the sheet orientation is “landscape” and the image 180-degree rotation function has been enabled (YES in the step S1118), the processing proceeds to a step S1119. On the other hand, in the case where the sheet orientation is “landscape” and the image 180-degree rotation function has not been enabled (NO in the step S1118), the processing proceeds to a step S1121. The processes in the steps S1121 and S1122 are the same as the processes in the steps S819 and S820 that have been described with reference to FIG. 9, so description thereof is omitted.

In the step S1119, the print data editing unit UI display unit 209 calculates the number of pixels (a pixel count) in an image missing area on the left portion of the Bitmap image where image missing occurs during printing by the printing apparatus 102. It should be noted that the calculation of the number of pixels (the pixel count) is performed based on the height of the Bitmap image, the height of the sheet size, and the borderless printing extension amount in the Top direction.

Next, in a step S1120, the print data editing unit UI display unit 209 calculates the number of pixels (a pixel count) in an image missing area on the right portion of the Bitmap image where image missing occurs during printing by the printing apparatus 102. It should be noted that the calculation of the number of pixels (the pixel count) is performed based on the height of the Bitmap image, the width of the sheet size, and the borderless printing extension amount in the bottom direction. Next, the processing proceeds to the step S1111. The processes from the steps S1111 to S1113 are the same as the processes from the steps S814 to S816 that have been described with reference to FIG. 9, so description thereof is omitted.

A print preview screen displayed in the case where the image 180-degree rotation function and the borderless printing function have been enabled and the sheet orientation is “landscape”, which is generated by the above processing, is a screen shown in FIG. 12B.

In a preview image display area 1205 on a print preview screen 1204 shown in FIG. 12B, the Bitmap image, which has been generated based on the XPS image data obtained by the print data editing unit UI display unit 209 from the OS, is displayed. Since the XPS image data that forms the basis of the Bitmap image does not reflect the image 180-degree rotation, the same image as in the case where the image 180-degree rotation function has not been enabled is displayed on the preview image display area 1205. On the other hand, an image missing area display frame line 1206, which is calculated based on the processing shown in FIG. 11, correctly displays the image missing area that occurs in the case where the image is rotated by 180 degrees and printed by the printing apparatus 102, by performing the calculation after exchanging the extension amount in the Top direction and the extension amount in the bottom direction.

The above is an example of the case where the image 180-degree rotation function and the borderless printing function have been selected simultaneously on the print setting screen extending unit 205 of the extension application 204. In this case, the pre-print preview display when the image 180-degree rotation function and the borderless printing function have been enabled is performed by the print data editing unit UI display unit 209. By adopting the method that has been described in the second embodiment, it is possible to achieve the effect of suppressing performance degradation caused by the print data editing unit UI display unit 209 editing the XPS data. Furthermore, also in the case of rotating an image by 180 degrees and then performing printing, a method, which is capable of confirming (checking) in advance the image missing area that occurs when the image is enlarged by the printing apparatus 102, is provided. As a result, it is possible to display, on the print preview screen, an image (an impression) of the correct print result.

### Third embodiment

In the first embodiment and the second embodiment, the method, in which the image missing area is calculated based on the borderless printing extension amounts of the printing apparatus 102 that have been retained in advance by the extension application 204 and is displayed by superimposing on the pre-print preview screen, has been described. However, in the case where the printing apparatus 102 performs borderless printing, the value of the borderless printing extension amount used for image enlargement is not a fixed value. The value of the borderless printing extension amount used for image enlargement may differ depending on the type of the printing apparatus 102, and there may be a plurality of selectable borderless printing extension amounts in the printing apparatus 102. Therefore, the extension application 204 may directly obtain information about the borderless printing extension amounts that the printing apparatus 102 or another printer has, from the printing apparatus 102 that has been selected as the transmission destination for the print data. In addition, by instructing (designating) a borderless printing extension amount from the host computer 101 with respect to the printing apparatus 102, the printing apparatus 102 may be caused to perform printing by using the instructed (designated) borderless printing extension amount. In order to deal with the above issue, the third embodiment is proposed. It should be noted that the system configuration not specifically mentioned in the following description is the same as that in the first embodiment, and therefore the description is omitted. In addition, the processing flow not specifically mentioned in the following description is the same as that in the first embodiment, and therefore the description is omitted.

First, the processing performed by the print function extending unit 207, which obtains the information about the borderless printing extension amounts from the printing apparatus and also edits the print function information based on the obtained information, will be described. The print function extending unit 207 issues a “Get-Printer-Attributes” operation of the IPP to the printing apparatus 102 that has been selected as the transmission destination for the print data. As a result, information about settable values for the borderless printing extension amounts that the printing apparatus 102 has is requested. The printing apparatus 102 responds to the request that has been issued by the print function extending unit 207 with a response to the information about settable values for the borderless printing extension amounts. The information shown in FIG. 10 is one example of the response of the information about the settable values for the borderless printing extension amounts that the printing apparatus 102 responds to. In addition, the response that the printing apparatus 102 responds to may include information about a borderless printing extension amount that is currently being selected in the printing apparatus 102, in addition to the settable values. In addition, the response that the printing apparatus 102 responds to may include a default setting value for the borderless printing extension amounts that are capable of being set in the printing apparatus 102. In the third embodiment, the “medium borderless printing extension amount” indicated by the row 903 of the extension amount list 901 shown in FIG. 10 is the default setting value of the printing apparatus 102 and is described as the current selected value.

The print function extending unit 207 obtains the information about the borderless printing extension amounts of the printing apparatus 102, which is obtained as the response to the “Get-Printer-Attributes” operation, and then stores, in the shared information 210, the information about the borderless printing extension amounts of the printing apparatus 102 that has been obtained. Furthermore, the print function extending unit 207 edits the print function information based on the information about the borderless printing extension amounts of the printing apparatus 102 that has been obtained. The print function extending unit 207 registers and updates the settable values for the borderless printing extension amounts and the default setting value, as information about the print functions of the printing apparatus 102. In other words, the print function extending unit 207 registers, in the print function information, the “large borderless printing extension amount”, the “medium borderless printing extension amount”, the “small borderless printing extension amount”, and the “no borderless printing extension amount”, as the settable values for the borderless printing extension amounts. The print function extending unit 207 registers the “medium borderless printing extension amount” as the default setting value for the borderless printing extension amounts. It should be noted that in the present disclosure, the “no borderless printing extension amount” means that the image is enlarged as necessary so that the margins of the sheet become zero, and that borderless printing is performed. It should be noted that the information about the borderless printing extension amounts to be obtained by the print function extending unit 207 through the “Get-Printer-Attributes” operation of the IPP may be a known attribute value defined as a standard specification for the IPP. Alternatively, the information about the borderless printing extension amounts may be an attribute value defined independently by each vendor providing the extension application 204. In this way, the print function extending unit 207 obtains, from the printing apparatus 102, the information about the borderless printing extension amounts that are capable of being set in the printing apparatus 102. The print function extending unit 207 updates the print function information.

Next, an example of a screen displayed by the print setting screen extending unit 205, which is configured based on the PC generated based on the print function information updated by the print function extending unit 207, will be described with reference to FIG. 5C.

PC is generated based on print function information (not shown), to which a borderless printing extension amount selection function has been added by the print function extending unit 207. In other words, in the third embodiment, the borderless printing function, the print preview function, and the borderless printing extension amount selection function are added by the print function extending unit 207. As a result, the user becomes able to select these functions on a print setting screen 510 shown in FIG. 5C, which is displayed by the print setting screen extending unit 205. As shown in FIG. 5C, a control 511 is a control item that allows to select the settable values for the borderless printing extension amounts that have been obtained from the printing apparatus 102. The control 511 is a setting value that forms the basis of the printing apparatus 102 enlarging the image when performing borderless printing. The control 511 is an example of a second object. The step of displaying the control 511 is an example of a third display control step. It should be noted that the control 511 may be displayed in response to that performing borderless printing has been selected by using the control 504. In the third embodiment, it is possible to select the “large borderless printing extension amount”, the “medium borderless printing extension amount”, the “small borderless printing extension amount”, and the “no borderless printing extension amount” that have been added by the print function extending unit 207. In the third embodiment, it is assumed that the “large borderless printing extension amount” has been selected by using the control 511 on the print setting screen 510, borderless printing “ON” has been selected, and print preview display “ON” has been selected.

In the case where the above-described print functions and other print functions have been selected by the user and an OK button on the print setting screen 510 has been pressed by the user, the print setting screen extending unit 205 reflects the selected print functions to the PT. Next, when the user performs a print instruction operation to the rendering application 201, the borderless printing function “ON” has been selected and the “large borderless printing extension amount” has been selected. As a result, the PT that has been updated to the state where the print preview display is turned on, along with the intermediate data, is transmitted from the rendering application 201 to the print data editing unit 208. It should be noted that also in the third embodiment, the processing of the print data generation software 202 is skipped. The intermediate data and the PT are transmitted directly to the print data editing unit 208 of the extension application 204.

### Processing performed by print data editing unit and print data editing unit UI display unit when borderless printing extension amount is set

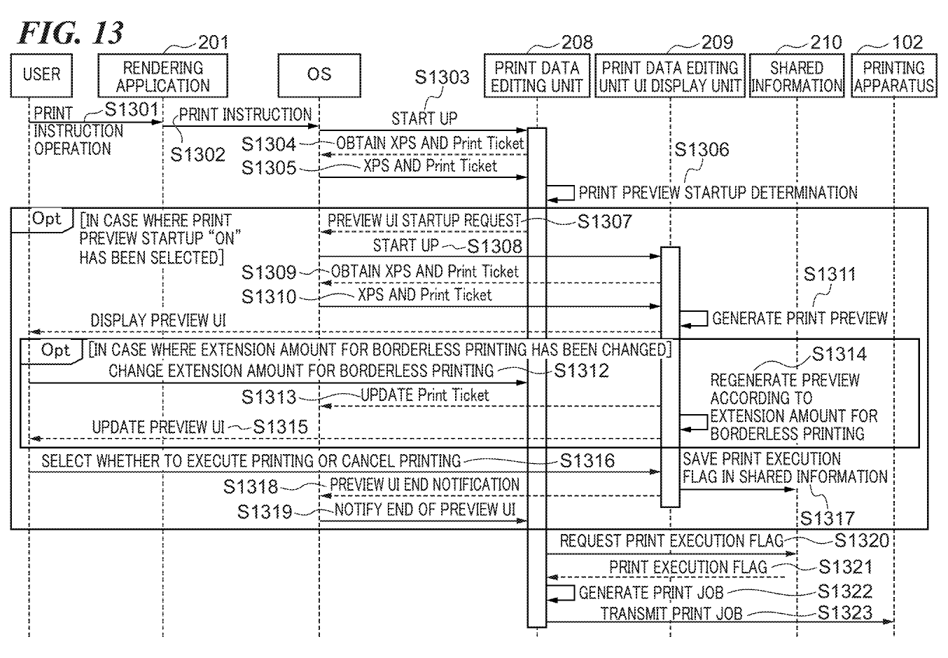

Next, the processes performed by the print data editing unit 208 and the print data editing unit UI display unit 209 in the case where the borderless printing function has been enabled and the “large borderless printing extension amount” has been set will be described with reference to a sequence diagram shown in FIG. 13. The processes from steps S1301 to S1310 in FIG. 13 are the same as the processes from the steps S701 to S710 that have been described with reference to FIG. 7, so description thereof is omitted.

Next, in a step S1311, the print data editing unit UI display unit 209 generates an image for print preview (a print preview image) to be displayed on the display unit 119. The print data editing unit UI display unit 209 converts the XPS data into a Bitmap image in the same manner as the processing that has been described with reference the flowchart of FIG. 7 of the first embodiment. In addition, the print data editing unit UI display unit 209 calculates an image missing area on the Bitmap image based on the sheet orientation, the sheet size, and the information about the borderless printing extension amount. The print data editing unit UI display unit 209 renders an image missing area display frame line based on the value of the calculated image missing area.

In the third embodiment, the borderless printing extension amount for calculating the image missing area is a setting value that has been selected by the user from among the settable values obtained from the printing apparatus 102 and has been reflected in the PT. If the setting value that has been reflected in the PT is the “large borderless printing extension amount”, the print data editing unit UI display unit 209 obtains borderless printing extension amounts in respective directions related to the “large borderless printing extension amount” stored in the shared information 210. In other words, the print data editing unit UI display unit 209 obtains respective borderless printing extension amounts in the Top, Bottom, Left, and Right directions, and also calculates the image missing area based on the borderless printing extension amounts in the “large borderless printing extension amount”.

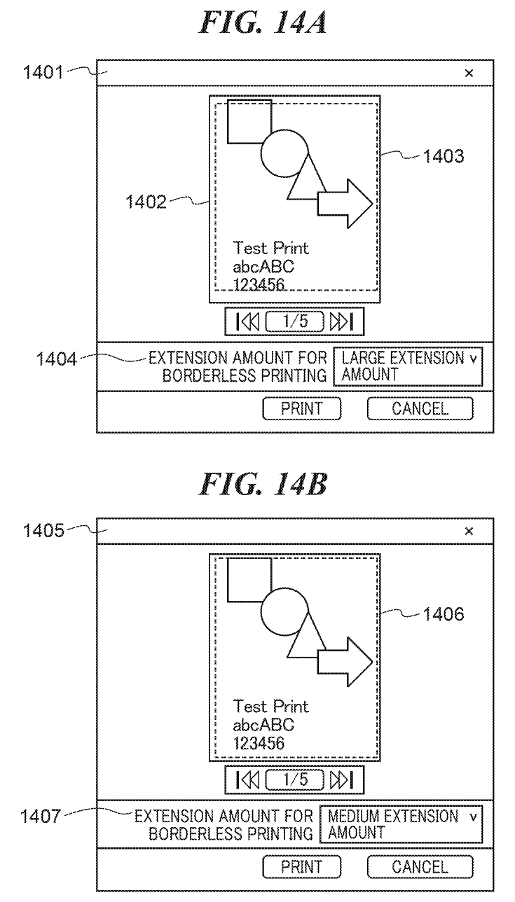

A print preview screen 1401 in the state where the borderless printing extension amount selection has been performed will be described with reference to FIGS. 14A and 14B. As shown in FIG. 14A, the print preview screen 1401 is a screen on which the Bitmap image for print preview and a frame line for representing the area where image missing occurs are displayed by superimposing by the print data editing unit UI display unit 209. In a preview image display area 1402 on the print preview screen 1401, the Bitmap image, which has been generated based on the XPS image data obtained by the print data editing unit UI display unit 209 from the OS, is displayed. An image missing area display frame line 1403 is a frame line that has been rendered by the print data editing unit UI display unit 209 while calculating the image missing area. The print data editing unit UI display unit 209 obtains the setting value that has been selected by the user via the control 511 and has been reflected in the PT, and also calculates the image missing area. In addition, the print preview screen 1401 of the third embodiment includes a control 1404. The control 1404 is a control item that allows to select the settable values for the borderless printing extension amounts that have been obtained from the printing apparatus 102. The control 1404 is an example of the second object. The step of displaying the control 1404 is an example of the third display control step.

Here, the borderless printing extension amount that has been selected by the control 1404 is a setting value that forms the basis of the printing apparatus 102 enlarging the image when performing borderless printing. The user changes the setting value for the borderless printing extension amount by using the control 1404. The print data editing unit UI display unit 209 obtains borderless printing extension amounts based on the setting value for the borderless printing extension amount that has been changed by the user. The print data editing unit UI display unit 209, after obtaining the borderless printing extension amounts, re-calculates the image missing area, re-renders the image missing area display frame line 1403, and updates the print preview screen 1401.

Steps from a step S1312 onwards in FIG. 13 represent a sequence in the case where the setting value for the borderless printing extension amount has been changed by the user by using the control 1404 on the print preview screen 1401 shown in FIG. 14A. In the step S1312, the user changes the setting value for the borderless printing extension amount. In the third embodiment, the setting value for the borderless printing extension amount is changed by the user from the “large borderless printing extension amount” to the “medium borderless printing extension amount”.

Next, in a step S1313, the print data editing unit UI display unit 209 updates the setting value for the borderless printing extension amount that is included in the PT, in accordance with that the “medium borderless printing extension amount” has been selected.

Next, in a step S1314, the print data editing unit UI display unit 209 re-calculates the image missing area based on the borderless printing extension amounts corresponding to the setting value for the borderless printing extension amount that has been changed. The print data editing unit UI display unit 209, after re-calculating the image missing area, re-renders the image missing area display frame line. The print data editing unit UI display unit 209 re-generates the print preview screen. Next, in a step S1315, the print data editing unit UI display unit 209 updates the print preview screen.

FIG. 14B shows a print preview screen 1405 after the print data editing unit UI display unit 209 has re-calculated the image missing area, has re-rendered the image missing area display frame line, and has updated the print preview screen. As shown in FIG. 14B, an image missing area display frame line 1406 on the print preview screen 1405 is a frame line that has been re-rendered by the print data editing unit UI display unit 209 in accordance with that the setting value for the borderless printing extension amount has been changed to the “medium borderless printing extension amount”.

In accordance with that the setting value for the borderless printing extension amount has been changed from the “large borderless printing extension amount” to the “medium borderless printing extension amount”, comparing the print preview screen 1401 and the print preview screen 1405, the image missing area on the print preview screen 1405 is smaller than the image missing area on the print preview screen 1401. In addition, on the print preview screen 1405, the selected value of a control 1407, which allows to select the setting value for the borderless printing extension amount, is also updated to the “medium borderless printing extension amount” and then displayed.

Next, in a step 1316, the user chooses whether to execute printing or cancel printing. The processes from steps S1315 to S1319 are the same as the processes from the steps S713 to S716 that have been described with reference to FIG. 7, so description thereof is omitted.

Next, in a step S1320, the print data editing unit 208 receives a notification that the processing of the print data editing unit UI display unit 209 has ended. After receiving the notification, the print data editing unit 208 requests a print execution flag, which has been stored in the shared information 210, from the shared information 210. Next, in a step S1321, the print data editing unit UI display unit 209 obtains the print execution flag. The print data editing unit 208 determines whether to execute printing or cancel printing. In the third embodiment, the case of executing printing will be described.

Next, in a step S1322, the print data editing unit 208 generates a print job in order to execute printing. Next, in a step S1323, the print data editing unit 208 transmits the generated print job to the printing apparatus 102. The print job includes image data for performing printing with the printing apparatus 102 and information about print attribute values for performing printing with the IPP. In the third embodiment, the setting value for the borderless printing extension amount that has been selected by the user is included in the print attribute values. The printing apparatus 102 receives the print job that has transmitted from the host computer 101. The printing apparatus 102 enlarges the image in accordance with borderless printing extension amounts that have been set in the print attribute values (in accordance with the setting value for the borderless printing extension amount included in the print attribute values) and executes borderless printing.

The above is an example, in which the settable values for the borderless printing extension amounts are obtained from the printing apparatus 102 and then added to the print function information, thereby making it possible to change the setting value for the borderless printing extension amount with the extension application 204. In addition, the above is an example, in which the pre-print preview display according to the setting value for the borderless printing extension amount that has been selected by the print data editing unit UI display unit 209 is performed. In addition, in this example, the setting value for the borderless printing extension amount is changed by the control provided by the print data editing unit UI display unit 209. As a result, it is possible to confirm (check) the print result that is based on the setting value for the borderless printing extension amount that has been changed, and it is also possible to confirm (check) print finish with the print preview while changing the setting value for the borderless printing extension amount and then execute printing. Therefore, it becomes possible to reduce the number of cases in which misprints occur for the user, and since there is no need to re-open the print setting screen extending unit 205 to perform a setting change, it is also possible to achieve an improvement in usability. It should be noted that the present disclosure is not limited to this example, and the setting value for the borderless printing extension amount may be changed by using only the control provided by the print setting screen 510. In addition, the setting value for the borderless printing extension amount may be changed by using only the control provided by the print data editing unit UI display unit 209 without providing, on the print setting screen 510, a control for changing the setting value for the borderless printing extension amount.

As described above, according to each of the embodiments that have been described above, in the case where the user performs OS standard printing, and borderless printing using the extension application 204, it is possible to confirm (check) on the print preview screen, the image missing area caused by the printing apparatus 102 enlarging the image. In addition, by providing a method of changing the setting value for borderless printing on the print preview screen, it becomes possible to select the borderless printing extension amount while confirming (checking) the print preview. As a result, it becomes easier for the user to select an expected result for the user, and the value of using OS standard printing and the extension application 204 for the user is improved.

### Fourth embodiment

In the fourth embodiment, a configuration, in which the extension application 204 is started up independently, will be described. The user is able to start up the extension application 204 independently by designating the extension application 204 from a list screen (not shown) of applications that have been installed on the host computer 101. The extension application 204 displays two types of first-time startup dialogs (a first first-time startup dialog and a second first-time startup dialog) when the extension application 204 is started up for the first time.

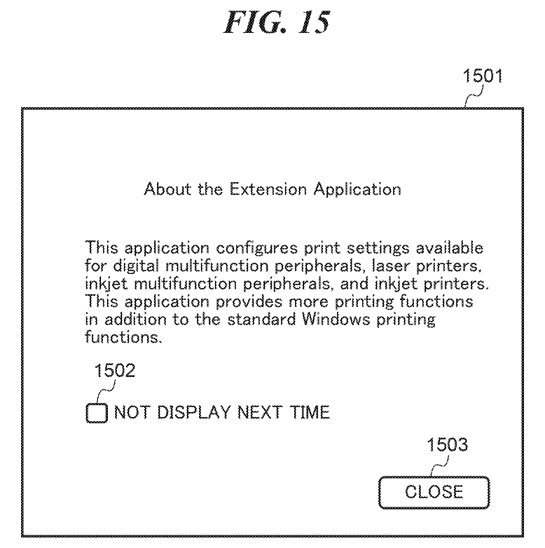

FIG. 15 illustrates an overview dialog 1501, which is the first first-time startup dialog. The extension application 204 displays the overview dialog 1501 when the extension application 204 is started up for the first time. A description indicating a function overview of the extension application 204 is described (included) in the overview dialog 1501. In addition, the overview dialog 1501 includes a checkbox 1502 that allows the user to designate whether or not to display this dialog (the overview dialog 1501) on subsequent startups. In the case where the user has checked the checkbox 1502, when the extension application 204 is started up independently the next time, the extension application 204 will not display the overview dialog 1501. On the other hand, in the case where the user has not checked the checkbox 1502, when the extension application 204 is started up independently the next time, the extension application 204 will display the overview dialog 1501 again. In addition, when the user presses a “close” button 1503, the extension application 204 closes the overview dialog 1501.

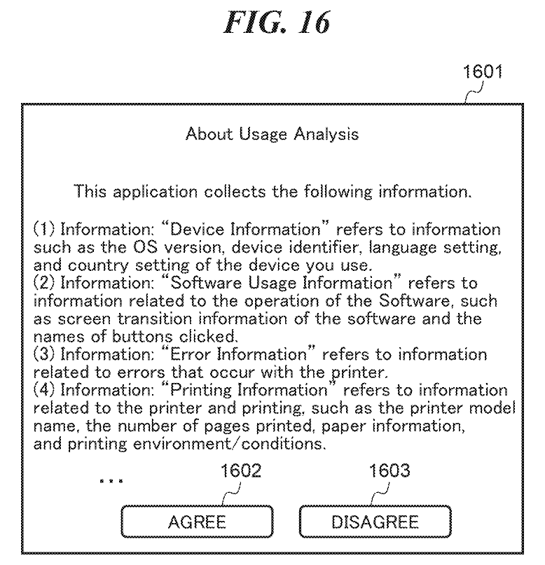

FIG. 16 illustrates an information transmission permission dialog 1601, which is the second first-time startup dialog. The information transmission permission dialog 1601 is displayed when the user presses the “close” button 1503 located on the screen of the overview dialog 1501 (an example of a display control step). The information transmission permission dialog 1601 displays sentences (text) for explaining the collection of various types of information for a usage analysis to be used by the provider of the extension application 204. The

information transmission permission dialog 1601 includes an “agree” button 1602 (an example of a permission section) and a “disagree” button 1603 (an example of a non-permission section). In the case where the user agrees to the usage analysis, the extension application 204 is capable of obtaining an instruction indicating agreement (consent) by accepting the selection of the “agree” button 1602 (the example of the permission section) (an example of an accepting step). The extension application 204 collects various types of information (an example of usage information) to be used for the usage analysis only in the case where the “agree” button 1602 has been pressed. The extension application 204 transmits the collected information to a usage analysis server (an example of an external server) (an example of a transmitting step). As the information to be used for the usage analysis, the extension application 204 obtains, for example, the names of a printer that is running in association with the extension application 204 204. As the information to be used for the usage analysis, the extension application 204 obtains, for example, information about screens started up or transitioned to by the user when various screens of the extension application 204 are started up or when screen transitions occur. As the information to be used for the usage analysis, the extension application 204 obtains, for example, the type of a button that has been pressed by the user. As the information to be used for the usage analysis, the extension application 204 obtains, for example, when the print button is pressed on the print setting screen and the print data is transmitted, the print setting information that has been set. As the information to be used for the usage analysis, the extension application 204 obtains, for example, when an error occurs in the printer (the printing apparatus 102), information about the error that occurred in the printer (the printing apparatus 102). As the information to be used for the usage analysis, the extension application 204 obtains, for example, information related to a usage environment, such as OS settings when using the extension application 204.

In the case where the user disagrees to the usage analysis, the extension application 204 is capable of obtaining an instruction indicating disagreement by accepting the selection of the “disagree” button 1603 (the example of the non-permission section) (an example of the accepting step). In the case where the “disagree” button 1603 has been pressed, the extension application 204 will not collect any and all various types of information to be used for the usage analysis. It should be noted that in the case where the transmission of the collected information to the usage analysis server has failed, the extension application 204 may create a folder in a predetermined area within the host computer 101. The extension application 204 may then save (store) the collected information as cache data in the folder. As a result, the extension application 204 is capable of re-transmitting the collected data (the collected information) to the usage analysis server at a predetermined timing. The predetermined timing is, for example, a timing when communication with the usage analysis server is restored. In addition, as the folder to save (store) the cache data, the extension application 204 may create a folder whose folder name is a hashed version of an inherent ID (an example of an inherent value) of the extension application 204. As a result, the extension application 204 is capable of making it difficult to determine from the outside where the information saved (stored) in the folder whose folder name is the hashed version of the inherent ID of the extension application 204 is located. The folder name is not limited to the hashed version of the inherent ID of the extension application 204, but may change according to a predetermined rule that has been set in the extension application 204.

In addition, the display or non-display of the information transmission permission dialog 1601 may be switched in accordance with laws of a country or region. Specifically, before displaying the information transmission permission dialog 1601, the extension application 204 refers to regional information relating to the country or region that has been set in the host computer 101 (an example of a referencing step). Country or region information (the regional information relating to the country or region) is set in the host computer 101 by the user or is set in advance in the host computer 101. The extension application 204 includes information about countries or regions that prohibit the collection of various types of information to be used for the usage analysis. The extension application 204 determines whether or not the collection of various types of information to be used for the usage analysis has been prohibited in the country or region indicated by the country or region information that has been set in the host computer 101 (an example of a collection determining step). In the case where the collection of various types of information to be used for the usage analysis has been prohibited in the country or region indicated by the country or region information that has been set in the host computer 101, the extension application 204 may omit the display of the information transmission permission dialog 1601. The information transmission permission dialog 1601 is a dialog that is displayed only once when the extension application 204 is started up for the first time, and is not displayed on subsequent startups.

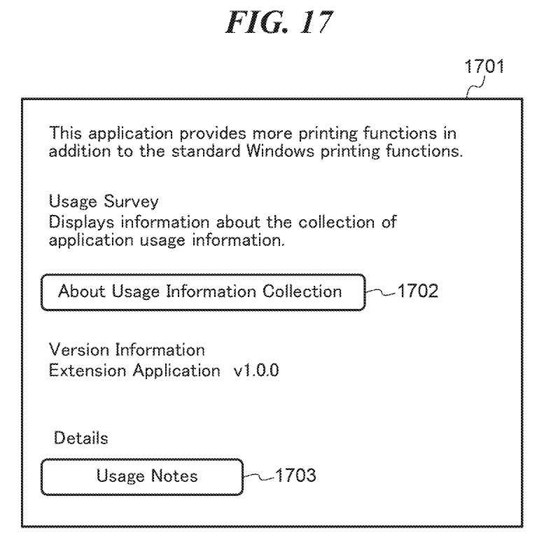

FIG. 17 illustrates an independent startup screen 1701 (an example of a main screen) of the extension application 204. The independent startup screen 1701 is a screen for starting the obtainment of the capability information of the printing apparatus 102. The independent startup screen 1701 includes a button 1702 (an example of a dialog selecting section) for displaying the information transmission permission dialog 1601 at any timing. In addition, the independent startup screen 1701 displays version information of the extension application 204. In addition, the independent startup screen 1701 includes a link button 1703 to a web manual explaining how to use the extension application 204. When the user selects the button 1702 (an example of the accepting step), the extension application 204 displays the information transmission permission dialog 1601 that has been described with reference to FIG. 16 (an example of the display control step). As a result, the user is able to switch at any timing whether or not information collection for the usage analysis at any timing is capable of being performed. The version information of the extension application 204 is represented as a string. When the extension application 204 displays the independent startup screen 1701, the extension application 204 obtains the application version information that has been stored in the host computer 101. As a result, the extension application 204 becomes capable of displaying the version information. Furthermore, by pressing the link button 1703, the user is able to display the web manual explaining how to use the extension application 204 at any timing. The web manual contains instructions on how to use the application and how to deal with problems that may occur during use. It should be noted that in the case where the collection of various types of information to be used for the usage analysis has been prohibited in the country or region indicated by the country or region information that has been set in the host computer 101, the extension application 204 may not display the button 1702.

### Fifth embodiment

In the fifth embodiment, a function will be described in which the extension application 204 obtains a resource file located outside the application package such as an external server, and switches its operation based on the obtained resource file. In the case where the print function extending unit 207 is not capable of detecting the extended function of the printing apparatus 102, the print function extending unit 207 is not capable of adding the extended function of the printing apparatus 102 to the print function information 203. Therefore, the extension application 204 is not capable of issuing a print instruction that uses the extended function of the printing apparatus 102. On the other hand, there may be extended functions in the printing apparatus 102 that have not been detected. Therefore, an improvement in the usability of the extension application 204 is desired.

In the fifth embodiment, the extension application 204 is capable of obtaining the resource file located on the external server at the start time of any one processing. Specifically, the start time of any one processing may be the time when the extension application 204 is started up independently, or may be the start time of the processing performed by the print data editing unit 208 and the print data editing unit UI display unit 209. The resource file describes (includes), for example, information that is not capable of being obtained from the printing apparatus 102. It should be noted that the extension application 204 saves the obtained resource file to a designated folder within the host computer 101. The extension application 204 is an application program that supports a general purpose program. The general purpose program is a program that is capable of causing the information processing apparatus to obtain the capability information of the printing apparatus in accordance with the Internet Printing Protocol. The extension application 204 causes the computer to execute an obtaining step of obtaining a resource file, in which a function possessed by the printing apparatus 102 has been described. The extension application 204 causes the computer to execute a function determining step of determining the function of the printing apparatus 102 that instructs printing based on the resource file. The extension application 204 causes the computer to execute an instructing step of instructing the printing apparatus 102 to perform the function, based on the determined function of the printing apparatus 102.

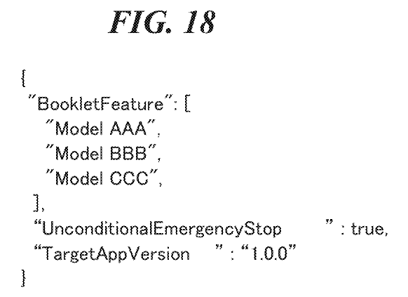

FIG. 18 illustrates a description example of the resource file. In the description example shown in FIG. 18, the model name of the printing apparatus 102, which possesses a bookbinding print function (Booklet Feature), is expressed in JSON (JavaScript Object Notation) format. The extension application 204 is capable of providing the bookbinding print function to the printing apparatus 102, which is equipped with the bookbinding print function, by obtaining the resource file shown in FIG. 18. In addition, by obtaining the resource file shown in FIG. 18 (an example of the obtaining step), the extension application 204 becomes capable of providing the bookbinding print function even to a printing apparatus 102, which is not capable of being determined whether or not the printing apparatus 102 is equipped with the bookbinding print function. Specifically, the extension application 204 refers to a string indicating the model name that has been obtained from the printing apparatus 102. The extension application 204 is capable of determining whether or not the bookbinding print function exists based on whether or not the model name of the printing apparatus 102 is present within a list indicated by “BookletFeature” (an example of the function determining step). In addition, even among models equipped with the bookbinding print function, there may be an increase in the number of the printing apparatuses 102 whose presence or absence of the bookbinding print function is not capable of being determined due to communication processing. The content of the resource file located on the external server is updated in accordance with the connected printing apparatuses 102. In other words, among the connected printing apparatuses 102, the model names of the printing apparatuses 102 equipped with the bookbinding print function are added to the list indicated by “BookletFeature”. As a result, it becomes possible to switch the operation of the extension application 204 without making any changes to the extension application 204 itself. In other words, the extension application 204 is capable of instructing the printing apparatus 102 to perform the bookbinding print function (an example of the instructing step).

As another example of its use, the resource file is also capable of being used for an emergency stop function of the information collection function by the extension application 204 for the usage analysis. Specifically, this could be a case where “UnconditionalEmergencystop” within the resource file indicates “true”. In this case, the extension application 204 is capable of stopping the information collection function even if the user has consented to information transmission by the operation of the information transmission permission dialog 1601. As a result, even in the case where the information collection has become impossible (improper) due to changes in the laws of the country or region, it becomes possible to stop the information collection processing without making any changes to the extension application 204 itself. Furthermore, the extension application 204 may execute an emergency stop of the information collection function with respect to a specific version of the extension application 204 by referring to “TargetAppVersion” within the resource file. Specifically, this could be a case where the version of the extension application 204 that has been installed on the host computer 101 is less than or equal to the version indicated by “TargetAppVersion”. In this case, the extension application 204 may apply (execute) an emergency stop of the information collection function. The extension application 204 may display, to the user, the stop of the information collection function.

In addition, the resource file may be retained in advance within the application package. As a result, even in the case where obtaining the resource file located outside the application package has failed, the extension application 204 is able to refer to (access) the resource file that has been retained stored within the application package. The extension application 204 is capable of switching its operation within the scope of information that has been described in the referenced resource file. In addition, the extension application 204 may manage the obtained resource file by associating the obtained resource file with user information. As a result, in the case where there are a plurality of users on the host computer 101, the extension application 204 is capable of managing the resource file obtained on a per-user basis.

According to the present disclosure, it is possible to provide a mechanism for improving the convenience (usability) of the extension application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070828, filed April 22, 2025, which is hereby incorporated by reference herein in its entirety.

What is claimed is:

1. A non-transitory computer-readable storage medium storing an application program that supports a general purpose program capable of causing an information processing apparatus to obtain capability information of a printing apparatus in accordance with the Internet Printing Protocol, the application program for causing a computer to execute
a display control step of displaying an information transmission permission dialog that includes a permission section, which accepts a choice that consents to collection of usage information to be used for usage analysis, and a non-permission section, which accepts a choice that does not consent to the collection;
an accepting step of accepting the choice of the permission section or the non-permission section; and
a transmitting step of, in a case where the permission section has been chosen, collecting the usage information and transmitting the collected usage information to an external server.

2. The non-transitory computer-readable storage medium according to claim 1, wherein
in a case where the non-permission section has been chosen, in the transmitting step, the collection of the usage information is stopped, and also the transmission of the collected usage information to the external server is stopped.

3. The non-transitory computer-readable storage medium according to claim 1, wherein
in the transmitting step, in a case where the usage information is not capable of being transmitted to the external server, the usage information is retained, and the retained usage information is transmitted to the external server at a predetermined timing.

4. The non-transitory computer-readable storage medium according to claim 3, wherein
in the transmitting step, the usage information is retained in a folder whose folder name is an inherent value of the application program.

5. The non-transitory computer-readable storage medium according to claim 1, wherein
the application program further causes the computer to execute
a referencing step of, prior to the display control step, referring to regional information relating to a country or region that has been set in the computer; and
a collection determining step of determining whether or not the collection of the usage information has been prohibited in the country or region indicated by the referenced regional information, and
in a case where the collection of the usage information has been prohibited in the country or region indicated by the regional information, in the display control step, the display of the information transmission permission dialog is omitted, and a main screen of the application program is displayed.

6. The non-transitory computer-readable storage medium according to claim 1, wherein
in the display control step, after the accepting step, a main screen of the application program is displayed.

7. The non-transitory computer-readable storage medium according to claim 6, wherein
after the accepting step, in the display control step, a dialog selecting section for displaying the information transmission permission dialog is displayed on the main screen,
in the accepting step, a choice of the dialog selecting section is accepted, and
based on the choice of the dialog selecting section, in the display control step, the information transmission permission dialog is displayed.

8. The non-transitory computer-readable storage medium according to claim 1, wherein
the application program further causes the computer to execute
an obtaining step of, prior to the display control step, obtaining a resource file, in which a function possessed by the printing apparatus has been described;
a function determining step of, prior to the display control step, determining the function of the printing apparatus that instructs printing based on the resource file; and
an instructing step of, after the accepting step, instructing the printing apparatus to perform the function, based on the determined function of the printing apparatus.

9. The non-transitory computer-readable storage medium according to claim 8, wherein
in the obtaining step, the resource file, in which a content that stops the collection of the usage information has been described, is obtained, and
in the transmitting step, the collection of the usage information is stopped, in accordance with the content that stops the collection of the usage information, which has been described in the resource file.

10. The non-transitory computer-readable storage medium according to claim 9, wherein
in the obtaining step, the resource file, in which a version of the application program that stops the collection of the usage information has been described, and a version of the application program that has been installed on the information processing apparatus, are obtained, and
in the transmitting step, in a case where the version of the application program that has been installed on the information processing apparatus is less than or equal to the version has been described in the resource file, the collection of the usage information is stopped.

11. A control method by an application program that supports a general purpose program capable of causing an information processing apparatus to obtain capability information of a printing apparatus in accordance with the Internet Printing Protocol, the control method comprising:
a display control step of displaying an information transmission permission dialog that includes a permission section, which accepts a choice that consents to collection of usage information to be used for usage analysis, and a non-permission section, which accepts a choice that does not consent to the collection;
an accepting step of accepting the choice of the permission section or the non-permission section; and
a transmitting step of, in a case where the permission section has been chosen, collecting the usage information and transmitting the collected usage information to an external server.

12. An information processing apparatus that retains an application program that supports a general purpose program capable of causing an information processing apparatus to obtain capability information of a printing apparatus in accordance with the Internet Printing Protocol, the information processing apparatus comprising:
at least one processor; and
a memory coupled to the processor storing the application program that, when executed by the processor, causes the processor to function as:
a display unit that displays an information transmission permission dialog that includes a permission section, which accepts a choice that consents to collection of usage information to be used for usage analysis, and a non-permission section, which accepts a choice that does not consent to the collection;
an accepting unit that accepts the choice of the permission section or the non-permission section; and
a transmitting unit that, in a case where the permission section has been chosen, collects the usage information and transmitting the collected usage information to an external server.
